(19) United States
(12) Patent Application Publication
(10) Pub. No.: US 2026/0042309 A1
(43) Pub. Date: Feb. 12, 2026

(54) THERMAL-TRANSFER RECORDING MEDIUM, TRANSFERRED-MEDIUM FILM, AND METHOD FOR PRODUCING TRANSFERRED-MEDIUM FILM

(71) Applicants: BROTHER KOGYO KABUSHIKI KAISHA, Nagoya-shi, Aichi (JP); General Co., Ltd., Osaka-shi, Osaka (JP)

(72) Inventors: Masaya FUJITA, Nagoya-shi, Aichi (JP); Satoru ITO, Nagoya-shi, Aichi (JP); Mina KATAOKA, Nagoya-shi, Aichi (JP); Haruki MATSUMOTO, Nagoya-shi, Aichi (JP); Yuki HOKARI, Nagoya-shi, Aichi (JP); Hiroaki NARUSE, Osaka-shi, Osaka (JP); Jiro HIRANO, Osaka-shi, Osaka (JP)

(73) Assignees: BROTHER KOGYO KABUSHIKI KAISHA, Nagoya-shi, Aichi (JP); General Co., Ltd., Osaka-shi, Osaka (JP)

(21) Appl. No.: 19/101,191

(22) PCT Filed: Aug. 2, 2023
(86) PCT No.: PCT/JP2023/028229

§ 371 Date: Feb. 4, 2025

(30) Foreign Application Priority Data
Aug. 5, 2022 (JP) 2022-125296

(51) Int. Cl. B41M 5/382; B41M 5/44

(52) U.S. Cl. CPC B41M 5/38228; B41M 5/38214; B41M 5/44; B41M 2205/06; B41M 2205/30

(57) ABSTRACT

A thermal transfer recording medium is a thermal transfer recording medium to be transferred to a transparent film, including: a base material layer; and a first ink layer and a second ink layer that are sequentially laminated on the base material layer, in which the second ink layer has translucency that allows for visual recognition of the first ink layer, and has a complementary color relationship with the first ink layer. Also, a transfer-completed film is a transfer-completed film with a first ink layer, a second ink layer having translucency that allows for visual recognition of the first ink layer, and a transparent film laminated in this order, in which the second ink layer has a complementary color relationship with the first ink layer.

### RELATED APPLICATION(S)

This application corresponds to Japanese Patent Application No. 2022-125296 filed with the Japan Patent Office on Aug. 5, 2022, the disclosure of which is incorporated herein by reference in its entirety.

### TECHNICAL FIELD

The present disclosure relates to a thermal transfer recording medium, a transfer-completed film, and a method of producing the same.

### BACKGROUND ART

Patent Literature 1 discloses a thermosensitive transfer material characterized in that at least a first ink layer and a second ink layer are sequentially provided on a support body in this order from the support body, and that the first ink layer contains a colorant having a color tone in a complementary color relationship with a color tone of the second ink layer.

### CITATION LIST

### Patent Literature

Patent Literature 1: Japanese Patent Application Publication No. 63-153186

### SUMMARY OF INVENTION

### Technical Problem

A preferred embodiment of the present disclosure provides a thermal transfer recording medium that, in a transfer-completed film in which a transfer pattern including a laminated body of a first ink layer and a second ink layer is visually recognized through a transparent film, can bring the color of the first ink layer visually recognized through the second ink layer close to an ideal color even when the second ink layer is a front surface side ink layer (observation surface side ink layer), a transfer-completed film, and a method of producing the same.

### Solution to Problem

A thermal transfer recording medium according to a preferred embodiment of the disclosure is a thermal transfer recording medium to be transferred to a transparent film, including a base material layer, and a first ink layer and a second ink layer that are sequentially laminated on the base material layer, in which the second ink layer has translucency that allows for visual recognition of the first ink layer, and has a complementary color relationship with the first ink layer.

### Advantageous Effects of Invention

In accordance with the thermal transfer recording medium according to the preferred embodiment of the present disclosure, the second ink layer has translucency that allows for visual recognition of the first ink layer. This makes it possible to form a film in which a laminated body of the first ink layer and the second ink layer is transferred to the transparent film such that the second ink layer serves as a front surface side ink layer (observation surface side ink layer). Since the second ink layer has translucency that allows for visual recognition of the first ink layer, the color of the first ink layer can be recognized through the second ink layer in this transfer-completed film. Further, the second ink layer has a complementary color relationship with the first ink layer. It is therefore possible to bring the color of the first ink layer visually recognized through the second ink layer close to an ideal color even when the first ink layer is covered with the second ink layer.

### BRIEF DESCRIPTION OF DRAWINGS

FIG. 1 is a view schematically illustrating a structure of a printing device according to a preferred embodiment of the present disclosure.

FIG. 2 is a block diagram illustrating an electrical configuration of the printing device.

FIG. 3 is a schematic view illustrating a heating step and a cooling step of the printing device.

FIGS. 4A and 4B are schematic views illustrating a cooling step and a transferring step of the printing device.

FIG. 5A is a schematic cross-sectional view illustrating a layer configuration of a transfer-completed tape according to a preferred embodiment of the present disclosure.

FIG. 5B is a schematic cross-sectional view illustrating a layer configuration of a transfer-completed tape according to a preferred embodiment of the present disclosure.

FIG. 5C is a schematic cross-sectional view illustrating a layer configuration of a transfer-completed tape according to a preferred embodiment of the present disclosure.

FIG. 5D is a schematic cross-sectional view illustrating a layer configuration of a transfer-completed tape according to a preferred embodiment of the present disclosure.

FIGS. 6A and 6B are views illustrating an example of a printing pattern of the printing device.

### DESCRIPTION OF EMBODIMENTS

Next, preferred embodiments of the present disclosure will be described in detail with reference to the accompanying drawings.

### [Overall Configuration of Printing Apparatus 1]

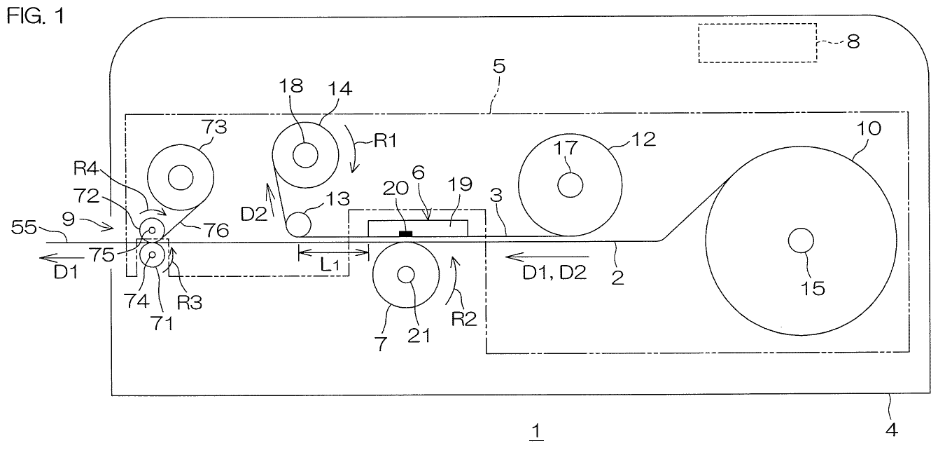

FIG. 1 is a view schematically illustrating a structure of a printing device 1 according to a preferred embodiment of the present disclosure.

With reference to FIG. 1, the printing device 1 is a thermal transfer printer that thermally transfers ink of an ink ribbon 3 as an example of a thermal transfer recording medium as characters to a printer tape 2 as an example of a printing target medium. In this preferred embodiment, the printer tape 2 is, for example, a transparent base material film to which ink is directly transferred. Here, the “transparency” of the printer tape 2 may be defined as that the printer tape 2 has such transparency that the shape and color of a character transferred to the printer tape 2 can be recognized from the side opposite to the transfer surface (printing surface).

Examples of characters to be recorded on the printer tape 2 may include a typical character, a symbol such as a barcode or a QR Code (registered trademark), a number, a figure, a pattern, and the like. The printing device 1 according to this preferred embodiment can record characters having different colors (for example, two colors including black and red) on the printer tape 2.

The printing device 1 mainly includes a housing 4, and a tape cassette 5, a thermal head 6, a platen roller 7, a nip roller 71, and a control board 8 which are housed within the housing 4.

The housing 4 may be a box-shaped member formed by, for example, a plastic case. An outlet 9 for taking out the printer tape 2 after printing is formed on an outer wall of the housing 4. A cutter (not illustrated) may be provided in the vicinity of the outlet 9. Cutting is performed using the cutter, and thereby the printer tape 2 can be separated into labels having a size for each usage unit and taken out.

The tape cassette 5 may be a removable cartridge with respect to the housing 4. The tape cassette 5 may accommodate a printer tape roll 10 (in other words, may be referred to as a label tape roll), an ink ribbon roll 12, an ink ribbon peeling member 13, an ink ribbon winding roll 14, a sticking roller 72, and a stick film roll 73 in this order from an upstream side to a downstream side in a tape transport direction D1 (a direction from right to left in FIG. 1). In this preferred embodiment, the printer tape roll 10, the ink ribbon roll 12, the sticking roller 72, and the stick film roll 73 are types used in a state of being accommodated in the tape cassette 5, but may be, for example, types used by being directly attached to the printing device 1.

The printer tape roll 10 is manufactured by winding the printer tape 2 in a cylindrical shape, and is rotatably held by the tape cassette 5, for example.

The ink ribbon roll 12 is manufactured by winding the ink ribbon 3 in a cylindrical shape, and is rotatably held by, for example, the tape cassette 5. A ribbon drive shaft 18 provided in the housing 4 is inserted into the ink ribbon winding roll 14. A rotative force R1 generated by driving the ribbon drive shaft 18 is transmitted to the ink ribbon winding roll 14, and the ink ribbon winding roll 14 is rotated.

The ink ribbon peeling member 13 may be a guide member that changes a transport direction D2 of the ink ribbon 3. The ink ribbon peeling member 13 may have a shape which can abut the ink ribbon 3 being transported, for example, a roller shape, or a blade shape. A part of the ink ribbon 3 is thermocompression-bonded to the printer tape 2 by the thermal head 6, and is transported together with the printer tape 2 toward the outlet 9. The ink ribbon peeling member 13 abuts the ink ribbon 3 in the middle of transport and changes the transport direction D2 of the ink ribbon 3 to a steep angle with respect to the transport direction D1 of the printer tape 2. Consequently, the printer tape 2 and the ink ribbon 3 are separated from each other, and the ink ribbon 3 is peeled from the printer tape 2.

A sticking roller drive shaft 75 provided in the housing 4, for example, can be inserted into the sticking roller 72. A rotative force R4 generated by driving the sticking roller drive shaft 75 is transmitted to the sticking roller 72, and the sticking roller 72 is rotated. As illustrated in FIG. 1, the sticking roller 72 is provided within the tape cassette 5 and partially exposed on the transport path of the printer tape 2. This makes it possible to transport the printer tape 2 by sandwiching between the sticking roller 72 and the nip roller 71 in a state where the tape cassette 5 is installed.

The stick film roll 73 is manufactured by winding a sticking tape 76 in a cylindrical shape, and is rotatably held by the tape cassette 5, for example.

The thermal head 6 is located between the ink ribbon peeling member 13 and both the printer tape roll 10 and the ink ribbon roll 12 in the transport direction D1 of the printer tape 2. The thermal head 6 includes a substrate 19 and a heating element 20 (for example, a heating resistor or the like) formed on the substrate 19. Joule heat generated by energization to the heating element 20 is used for thermal transfer of ink of the ink ribbon 3.

For example, a platen drive shaft 21 provided in the housing 4 is inserted into the platen roller 7. A rotative force R2 generated by driving the platen drive shaft 21 is transmitted to the platen roller 7, and the platen roller 7 is rotated.

For example, a nip roller drive shaft 74 provided in the housing 4 is inserted into the nip roller 71. A rotative force R3 generated by driving the nip roller drive shaft 74 is transmitted to the nip roller 71, and the nip roller 71 is rotated.

The control board 8 is an electronic instrument that executes electrical control of the printing device 1, and is installed inside the housing 4.

### [Electrical Configuration of Printing Device 1]

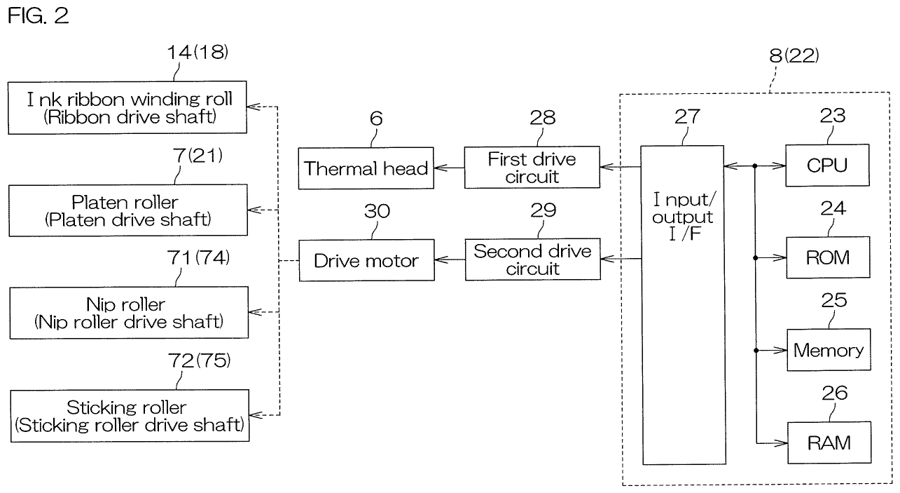

FIG. 2 is a block diagram illustrating an electrical configuration of the printing device 1.

With reference to FIG. 2, a control circuit 22 is provided on the control board 8 of the printing device 1. The control circuit 22 may include a CPU 23, a ROM 24, a memory 25, a RAM 26, and an input/output I/F 27 (interface) These elements are electrically connected through, for example, a data bus (not illustrated).

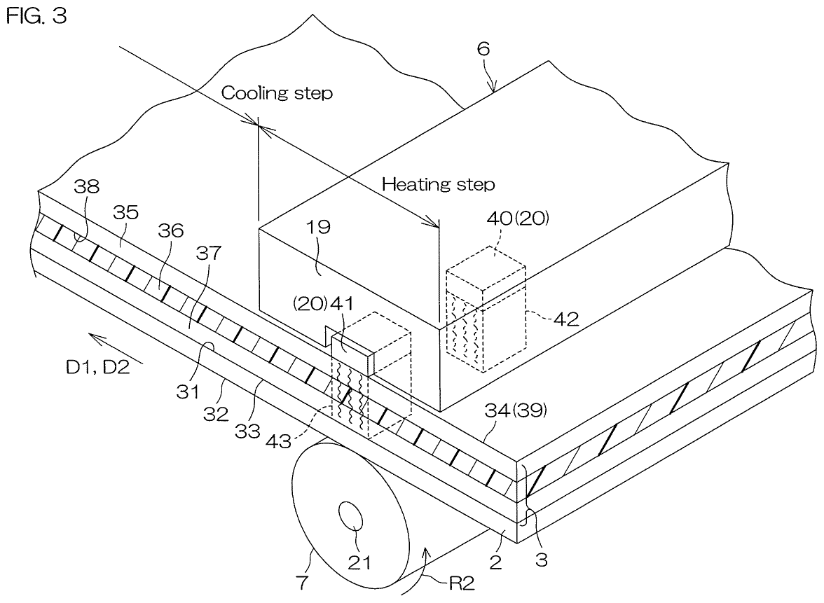

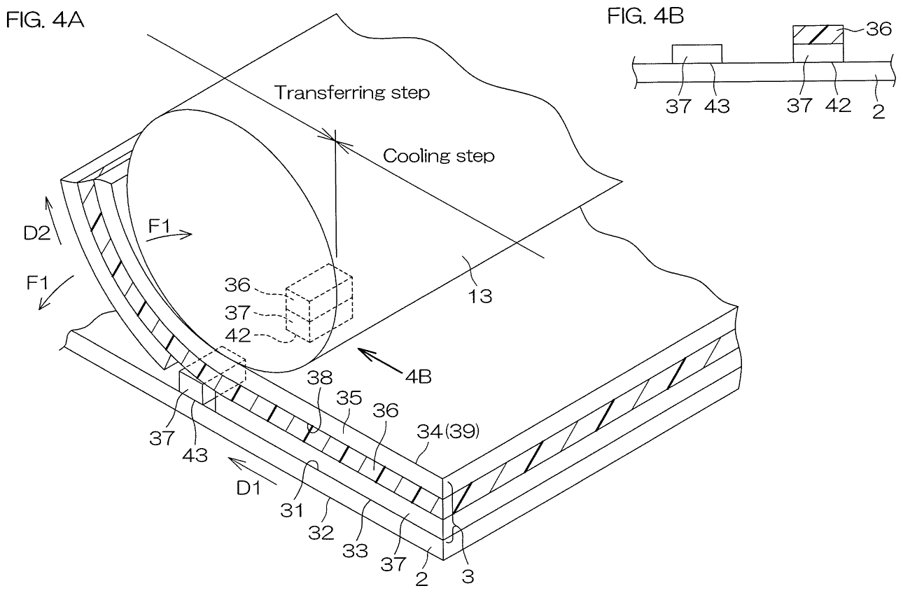

The ROM 24 stores various programs (for example, a control program or the like for executing steps illustrated in FIGS. 3 and 4A and 4B) for driving the printing device 1. The CPU 23 executes signal processing according to a program stored in the ROM 24 while using the temporary storage function of the RAM 26 and controls the printing device 1 as a whole. The memory 25 may be configured of, for example, a part of a storage region of the ROM 24. In the memory 25, a table for displaying a remaining amount (consumption amount) of the ink ribbon 3 on a display portion (not illustrated) of the housing 4 may be stored in advance.

A first drive circuit 28 and a second drive circuit 29 are electrically connected to the input/output I/F 27. The first drive circuit 28 executes energization control of the heating element 20 of the thermal head 6. The second drive circuit 29 executes drive control of outputting a drive pulse to a drive motor 30 that rotationally drives the ink ribbon winding roll 14, the platen roller 7, the nip roller 71, and the sticking roller 72.

### [Flow of Printing Step by Printing Device 1]

FIG. 3 is a schematic view illustrating a heating step and a cooling step of the printing device 1. FIGS. 4A and 4B are schematic views illustrating a cooling step and a transferring step of the printing device 1. FIG. 4B is an enlarged view of a main part when a transfer pattern is viewed from a direction of an arrow 4B in FIG. 4A. A printing step executed by the printing device 1 will be specifically described with reference to FIGS. 1, 3, 4A, and 4B.

In order to print characters on the printer tape 2, the printer tape 2 is pulled out from the printer tape roll 10 by rotationally driving the platen roller 7, and the ink ribbon 3 is pulled out from the ink ribbon roll 12 by rotationally driving the ink ribbon winding roll 14. Consequently, as illustrated in FIGS. 1 and 3, the printer tape 2 and the ink ribbon 3 are transported toward the downstream side in a state of overlapping each other. Regarding the printer tape 2, a surface on the ink ribbon 3 side is a printing surface 31 (front surface), and a surface on the opposite side thereof is a back surface 32. Regarding the ink ribbon 3, a surface on the printer tape 2 side is an adhesive surface 33 (front surface), and a surface on the opposite side thereof is a back surface 34.

With reference to FIG. 3, the ink ribbon 3 includes a base material layer 35, a first ink layer 36, and a second ink layer 37. The first ink layer 36 and the second ink layer 37 are laminated in this order on a front surface 38 as an example of a first surface of the base material layer 35. A surface on the opposite side to the front surface 38 of the base material layer 35 is a back surface 39 (the back surface 34 of the ink ribbon 3). The first ink layer 36 and the second ink layer 37 contain colorants having different colors.

The ink ribbon 3 is transported toward the thermal head 6 in a state in which the second ink layer 37 and the printer tape 2 are in contact with each other. In the thermal head 6, the heating step is executed as illustrated in FIG. 3. Specifically, the heating element 20 that generates heat due to energization is pressed against the ink ribbon 3, and thereby the heat is transmitted to the first ink layer 36 and the second ink layer 37 through the base material layer 35. A laminated body of the ink ribbon 3 and the printer tape 2 is sandwiched between the thermal head 6 and the platen roller 7, and thereby the laminated body is transported to the downstream side while being heated by the thermal head 6.

The heating element 20 may be controlled at the same temperature as a whole, or may be controlled at partially different temperatures. For example, as illustrated in FIG. 3, a first portion 40 of the heating element 20 may be controlled at a relatively low first heating temperature, and a second portion 41 of the heating element 20 may be controlled at a second heating temperature higher than the first heating temperature. The first heating temperature may be controlled by applying a relatively low first energy amount to the thermal head 6, and the second heating temperature may be controlled by applying a second energy amount that is relatively higher than the first energy amount to the thermal head 6.

The first heating temperature may be, for example, 60° C. or higher and 120° C. or lower, and preferably 70° C. or higher and 90° C. or lower. The second heating temperature may be, for example, 80° C. or higher and 180° C. or lower, and preferably 130° C. or higher and 150° C. or lower. The first energy amount and the second energy amount may be set in accordance with specifications of the printing device 1 such that the thermal head 6 is heated to the first heating temperature and the second heating temperature, respectively. For example, a voltage value may be set in the printing device 1 with specifications in which the energy amount to be applied can be set directly with a voltage value, or an energy amount at an appropriate stage may be set in the printing device 1 with specifications in which the energy amount to be applied is increased or decreased by adjusting the energy amount divided into multiple stages.

Consequently, the ink ribbon 3 may include a first portion 42 heated at the first heating temperature and a second portion 43 heated at the second heating temperature. In the first portion 42 and the second portion 43 of the ink ribbon 3, at least a part or all of the first ink layer 36 and the second ink layer 37 is melted or softened, and comes into close contact with the printer tape 2.

With reference to FIGS. 3, 4A, and 4B, the cooling step is executed in a zone between the thermal head 6 and the ink ribbon peeling member 13. Specifically, the ink ribbon 3 thermocompression-bonded to the printer tape 2 in the heating step is naturally cooled in a zone from the thermal head 6 to the ink ribbon peeling member 13, and the temperature decreases toward a use environmental temperature of the printing device 1.

Thereafter, as illustrated in FIGS. 4A and 4B, an external force F1 is applied to the base material layer 35 and the second ink layer 37 in a direction in which the layers are separated from each other, by causing the ink ribbon peeling member 13 to selectively change only the transport direction D2 of the ink ribbon 3. Consequently, the printer tape 2 and the ink ribbon 3 are separated from each other, and the ink ribbon 3 is wound around the ink ribbon winding roll 14. At this time, in the ink ribbon 3, the first portion 42 and the second portion 43 heated by the thermal head 6 selectively remain on the printer tape 2, and thereby the transferring step is executed. For example, in the first portion 42, peeling may occur between the base material layer 35 and a laminated body including the first ink layer 36 and the second ink layer 37, and the laminated body may be transferred. On the other hand, in the second portion 43, peeling may occur between the first ink layer 36 and the second ink layer 37, and the second ink layer 37 may be selectively transferred.

As illustrated in FIG. 1, a sticking tape 76 is then stuck to the printer tape 2 to which the first ink layer 36 and the second ink layer 37 have been transferred. A transfer-completed tape 55 formed by sticking the sticking tape 76 to the printer tape 2 and having characters recorded thereon is discharged through the outlet 9 of the printing device 1.

### [Layer Configuration of Transfer-Completed Tape 55]

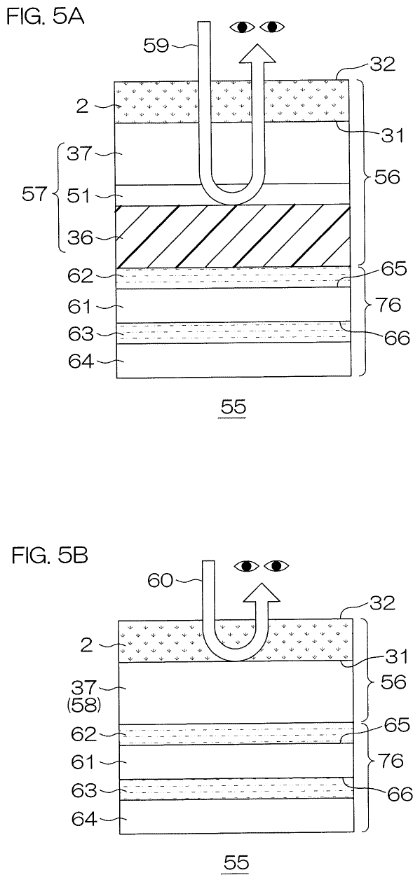

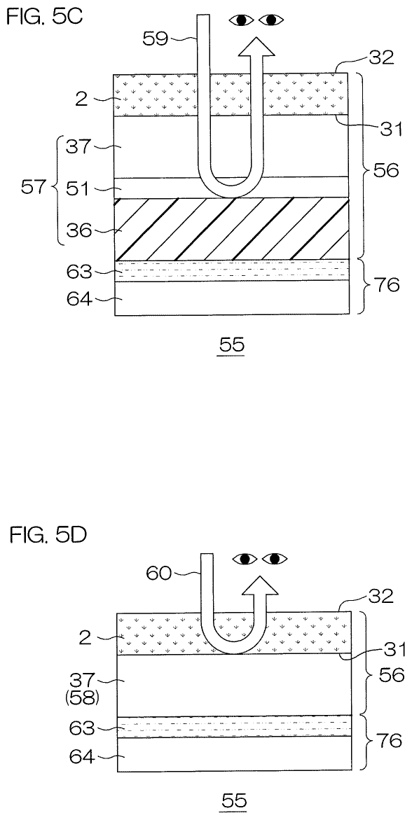

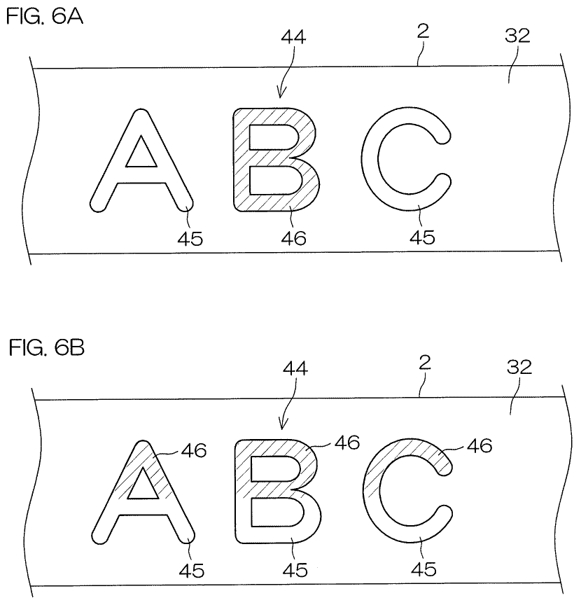

FIGS. 5A and 5B are schematic cross-sectional views illustrating a layer configuration of the transfer-completed tape 55 according to a preferred embodiment of the present disclosure. FIGS. 6A and 6B are views illustrating an example of a printing pattern 44 of the printing device 1.

With reference to FIGS. 5A and 5B, the transfer-completed tape 55 includes a print product 56 that includes the printer tape 2 to which a portion of the ink ribbon 3 is transferred, and the sticking tape 76 that is stuck to the print product 56. The sticking tape 76 may be referred to as a stick film. FIG. 5A illustrates a cross-section of a portion of the transfer-completed tape 55 to which the laminated body of the first ink layer 36 and the second ink layer 37 has been transferred as a first transfer layer 57. FIG. 5B illustrates a cross-section of a portion of the transfer-completed tape 55 to which the second ink layer 37 has been transferred selectively as a second transfer layer 58.

In the transfer-completed tape 55 of this preferred embodiment, the sticking tape 76 is formed as a support film that supports the first transfer layer 57 and the second transfer layer 58. The printer tape 2 is formed as a transparent cover film that physically protects the first transfer layer 57 and the second transfer layer 58 against the exterior. Accordingly, in the first transfer layer 57 and the second transfer layer 58, the second ink layer 37 on a side closer to the printer tape 2 is a front surface side ink layer (observation surface side ink layer). As indicated by open arrows 59, 60 in FIGS. 5A and 5B, a person can recognize the color of each of the first ink layer 36 and the second ink layer 37 via light transmitted through the printer tape 2 and reflected at the first ink layer 36 or the second ink layer 37.

The first transfer layer 57 and the second transfer layer 58 form printing patterns 44 of different colors on the transfer-completed tape 55. For example, as illustrated in FIG. 6A, the printing pattern 44 may have a different color for each independent character. In FIG. 6A, when the printing pattern 44 is viewed through the back surface 32 of the printer tape 2, a second color pattern 45 based on the second ink layer 37 may be recognized on the outermost surfaces of alphabets “A” and “C,” and a first color pattern 46 based on the first ink layer 36 may be recognized on the outermost surface of “B.” On the other hand, as illustrated in FIG. 6B, in the printing pattern 44, both the second color pattern 45 and the first color pattern 46 may be recognized for each portion of the characters.

Next, a layer configuration of the transfer-completed tape 55 will be described more specifically.

As mentioned above, the transfer-completed tape 55 is formed by sticking the print product 56 and the sticking tape 76 to each other.

The print product 56 includes the printer tape 2, and the first transfer layer 57 and the second transfer layer 58 that are formed selectively on the printing surface 31 of the printer tape 2. The first transfer layer 57 includes the second ink layer 37, a middle layer 51, and the first ink layer 36 that are sequentially laminated on the printing surface 31, and the second transfer layer 58 is the second ink layer 37 that is formed on the printing surface 31.

### (1) Printer Tape 2

The printer tape 2 is not particularly limited as long as it is a transparent base material film to which ink is directly transferred, and examples thereof include resin films such as polyester, polyethylene, polypropylene, polyamide, polyimide, polycarbonate, polystyrene, and fluororesin. Among them, a film of polyethylene terephthalate (PET), which is polyester, is preferable from the viewpoint of mechanical strength, dimensional stability, heat treatment resistance, price, or the like. The printer tape 2 may be a single layer of any of the resin films described above, or may be a laminated film formed by layering more than one of the resin films described above.

The thickness of the printer tape 2 can be set arbitrarily according to, for example, specifications of the thermal transfer printer, the characteristics required for the printer tape 2, and the like. For example, the printer tape 2 has a thickness of 1 μm or more, and preferably 10 μm or more. For example, the printer tape 2 has a thickness of 100 μm or less, and preferably 50 μm or less. For example, the printer tape 2 has a thickness of 1 μm or more and 100 μm or less, and preferably 10 μm or more and 50 μm or less. The printer tape 2, as long as having a thickness within this range, can exhibit sufficient mechanical strength and/or elasticity while imparting appropriate flexibility to the transfer-completed tape 55. The printer tape 2 may be thinner than the above range when placing significance on the flexibility of the transfer-completed tape 55. It is thereby possible to favorably stick the transfer-completed tape 55 even to a complicated curved surface. On the other hand, the printer tape 2 may be thicker than the above range when placing significance on the mechanical strength and/or elasticity of the transfer-completed tape 55. It is thereby possible to prevent generation of wrinkles in the printer tape 2 during transport in the printing device 1 and/or during sticking of the sticking tape 76.

The printer tape 2 may be an unstretched film that has not been subjected to stretching processing in the course of its production, or may be a stretched film that has been subjected to stretching processing such as uniaxial stretching and biaxial stretching. Also, the surfaces (the printing surface 31 and the back surface 32) of the printer tape 2 may be subjected to surface finish processing such as glossy finish or matte finish. Furthermore, a primer layer for improving printability onto the printer tape 2, an overcoat layer for adjusting frictional force, a peel-off layer that uses silicone for protecting the surfaces of the printer tape 2 before use, and the like may be formed separately. These layers may conceptually be part of the printer tape 2.

As a numerical value that represents the transparency of the printer tape 2, a total light transmittance, for example, may be used that is measured in conformity with JIS K 7361. The printer tape 2 may have a total light transmittance of, for example, 80% or more, and preferably 85% or more. The total light transmittance of the printer tape 2 can be measured using, for example, a haze meter.

### (2) First Ink Layer 36

The first ink layer 36 can be made of, for example, any thermoplastic resin. The first ink layer 36 is preferably formed using an epoxy resin as the thermoplastic resin in consideration of improving the affinity and the adhesion to the middle layer 51. The first ink layer 36 can be formed using, as a thermoplastic resin, an epoxy resin in a (excluding) state in which a curing agent is not blended.

Examples of the epoxy resin include a bisphenol A epoxy resin, a bisphenol F epoxy resin, a phenol novolac epoxy resin, a cresol novolac epoxy resin, an alicyclic epoxy resin, a hydrogenated bisphenol A epoxy resin, a hydrogenated bisphenol AD epoxy resin, an aliphatic epoxy resin such as propylene glycol glycoxyl ether or pentaerythritol polyglycidyl ether, an epoxy resin obtained from aliphatic or aromatic amine and epichlorohydrin, an epoxy resin obtained from aliphatic or aromatic carboxylic acid and epichlorohydrin, a heterocyclic epoxy resin, a spirocyclic epoxy resin, an epoxy-modified resin, a brominated epoxy resin, and the like. Specific examples of the epoxy resin are not particularly limited, but include, for example, the following various types of epoxy resin. These epoxy resins can be used individually or in combination of two or more kinds thereof.

Among the JER (registered trademark) series of epoxy resins manufactured by Mitsubishi Chemical Corporation, basic solid types 1001 [softening point (ring and ball method): 64° C., number average molecular weight Mn: about 900], 1002 [softening point (ring and ball method): 78° C., number average molecular weight Mn: about 1200], 1003 [softening point (ring and ball method): 89° C., number average molecular weight Mn: about 1300], 1055 [softening point (ring and ball method): 93° C., number average molecular weight Mn: about 1600], 1004 [softening point (ring and ball method): 97° C., number average molecular weight Mn: about 1650], 1004AF [softening point (ring and ball method): 97° C., number average molecular weight Mn: about 1650], 1007 [softening point (ring and ball method): 128° C., number average molecular weight Mn: about 2900], 1009 [softening point (ring and ball method): 144° C., number average molecular weight Mn: about 3800], 1010 [number average molecular weight Mn: about 5500], 1003F [softening point (ring and ball method): 96° C.], 1004F [softening point (ring and ball method): 103° C.], 1005F, 1009F [softening point (ring and ball method): 144° C.], 1004FS [softening point (ring and ball method): 100° C.], 1006FS [softening point (ring and ball method): 112° C.], and 1007FS [softening point (ring and ball method): 124° C.].

The softening point of the epoxy resin used in the first ink layer 36 is, for example, 95° C. or higher, preferably 110° C. or higher, and more preferably 125° C. or higher. When the softening point falls within this range, it is possible to prevent a high adhesive force from being generated between the first ink layer 36 and the base material layer 35 (see FIGS. 3, 4A, and 4B) at a relatively low temperature during low-temperature transfer. Since the low-temperature transfer range of the first ink layer 36 can be sufficiently widened toward a high temperature side, it is possible to prevent the color tones from becoming dusky even in the continuous thermal transfer recording.

The first ink layer 36 may contain an adhesive in addition to the epoxy resin. By containing the adhesive, the affinity and the adhesion to the middle layer 51 can be further improved. Examples of the adhesive include a rubber-based adhesive, an acrylic adhesive, a silicone-based adhesive, a vinyl alkyl ether-based adhesive, a polyvinyl alcohol-based adhesive, a polyvinylpyrrolidone-based adhesive, a polyacrylamide-based adhesives, a cellulose-based adhesive, and the like.

In consideration of improving affinity and compatibility with the epoxy resin and the affinity and the adhesion to the middle layer 51, the acrylic adhesive is preferable as the adhesive. Specific examples of the acrylic adhesive are not particularly limited, and include the following various acrylic adhesives. These acrylic adhesives can be used individually or in combination of two or more kinds thereof.

Among the ORIBAIN (registered trademark) BPS (solvent-based) series manufactured by Toyochem Co., Ltd., BPS1109 (nonvolatile content: 39.5 mass %), BPS3156D (nonvolatile content: 34 mass %), BPS4429-4 (nonvolatile content: 45 mass %), BPS4849-40 (nonvolatile content: 40 mass %), BPS5160 (nonvolatile content: 33 mass %), BPS5213K (nonvolatile content: 35 mass %), BPS5215K (nonvolatile content: 39 mass %), BPS5227-1 (nonvolatile content: 41.5 mass %), BPS5296 (nonvolatile content: 37 mass %), BPS5330 (nonvolatile content: 40 mass %), BPS5375 (nonvolatile content: 45 mass %), BPS5448 (nonvolatile content: 40 mass %), BPS5513 (nonvolatile content: 44.5 mass %), BPS5565K (nonvolatile content: 45 mass %), BPS5669K (nonvolatile content: 46 mass %), BPS5762K (nonvolatile content: 45.5 mass %), BPS5896 (nonvolatile content: 37 mass %), BPS5978 (nonvolatile content: 35 mass %), BPS6074HTF (nonvolatile content: 52 mass %), BPS6080TFK (nonvolatile content: 45 mass %), BPS6130TF (nonvolatile content: 45.5 mass %), BPS6153K (nonvolatile content: 25 mass %), BPS6163 (nonvolatile content: 37 mass %), BPS6231 (nonvolatile content: 56 mass %), BPS6421 (nonvolatile content: 47 mass %), BPS6430 (nonvolatile content: 33 mass %), BPS6574 (nonvolatile content: 57 mass %), BPS8170 (nonvolatile content: 36.5 mass %), and BPS HS-1 (nonvolatile content: 40 mass %).

Among solvent type adhesives (removable type) manufactured by Lion Specialty Chemicals Co., Ltd., AS-325 (solid concentration: 45 mass %), AS-375 (solid concentration: 45 mass %), AS-409 (solid concentration: 45 mass %), AS-417 (solid concentration: 45 mass %), AS-425 (solid concentration: 45 mass %), AS-455 (solid concentration: 45 mass %), AS-665 (solid concentration: 40 mass %), AS-1107 (solid concentration: 43 mass %), and AS-4005 (solid concentration: 45 mass %).

The acrylic adhesive used in the first ink layer 36 may be used in combination with a tackifier. This is because, for example, it is possible to increase the sharpness of the first ink layer 36, prevent the extra peeling, and improve the sharpness of the character to be recorded. Examples of the tackifier include ester gum, terpene phenolic resin, rosin ester, and the like. Specific examples of the tackifier are not particularly limited, and include the following various tackifiers. These tackifiers can be used individually or in combination of two or more kinds thereof.

Among the YS POLYSTER series of terpene phenol resins manufactured by YASUHARA CHEMICAL Co., Ltd., U130 (softening point: 130±5° C.), U115 (softening point: 115+±5° C.), T160 (softening point: 160±5° C.), T145 (softening point: 145±5° C.), T130 (softening point: 130±5° C.), T115 (softening point: 115±5° C.), T100 (softening point: 100±5° C.), T80 (softening point: 80±5° C.), S145 (softening point: 145±5° C.), G150 (softening point: 150±5° C.), G125 (softening point: 125±5° C.), N125 (softening point: 125±5° C.), K125 (softening point: 125±5° C.), and TH130 (softening point: 130±5° C.).

Among the ester gums manufactured by Arakawa Chemical Industries, Ltd., AA-G [softening point (ring and ball method): 82 to 88° C.], AA-L [softening point (ring and ball method): 82 to 88° C.], AA-V [softening point (ring and ball method): 82 to 95° C.], 105 [softening point (ring and ball method): 100 to 110° C.], AT [viscosity: 20,000 to 40,000 mPa·s], H [softening point (ring and ball method): 68 to 75° C.], and HP [softening point (ring and ball method): 80° C. or higher].

Among the PENSEL (registered trademark) series of rosin esters manufactured by Arakawa Chemical Industries, Ltd., GA-100 [softening point (ring and ball method): 100 to 110° C.], AZ [softening point (ring and ball method): 950 to 105° C.], C [softening point (ring and ball method): 117 to 127° C.], D-125 [softening point (ring and ball method): 120 to 130° C.], D-135 [softening point (ring and ball method): 130 to 140° C.], D-160 [softening point (ring and ball method): 150 to 165° C.], and KK [softening point (ring and ball method): 165° C. or higher].

The softening point of the tackifier used in the first ink layer 36 is, for example, 60° C. or higher, and preferably 120° C. or lower. When the softening point falls within this range, the first ink layer 36 and the middle layer 51 can be reversely transferred favorably to the base material layer 35 side at the time of high-temperature transfer. Since the high-temperature transfer range of the first ink layer 36 can be sufficiently widened to a low temperature side, it is possible to prevent the color tones from becoming dusky.

The first ink layer 36 may contain any colorant. As the colorant, one or more kinds of various colorants corresponding to the color tone of the first ink layer 36 can be used. For example, pigments or dyes may be used as the colorants. In consideration of the concealing property of the base, etc., the pigments are preferable as the colorants used in the first ink layer 36. That is, the color of the first ink layer 36 can be favorably recognized as the black color as a complementary color effect through the printer tape 2 and the second ink layer 37 by suppressing transmission of light through the first ink layer 36. Details of the colorant of the first ink layer 36 will be described below.

Ratios of components in the first ink layer 36 are not particularly limited. The ratio of the acrylic adhesive with respect to 100 parts by mass of the epoxy resin is, for example, 30 parts by mass or more, and preferably 40 parts by mass or more. The ratio of the acrylic adhesive with respect to 100 parts by mass of the epoxy resin is, for example, 150 parts by mass or less, and preferably 100 parts by mass or less. The ratio of the acrylic adhesive with respect to 100 parts by mass of the epoxy resin is, for example, 30 parts by mass or more and 150 parts by mass or less, and preferably 40 parts by mass or more and 100 parts by mass or less.

The ratio of the tackifier with respect to 100 parts by mass of the epoxy resin is, for example, 3 parts by mass or more, and preferably 5 parts by mass or more. The ratio of the tackifier with respect to 100 parts by mass of the epoxy resin is, for example, 150 parts by mass or less, and preferably 100 parts by mass or less. The ratio of the tackifier with respect to 100 parts by mass of the epoxy resin is, for example, 3 parts by mass or more and 150 parts by mass or less, and preferably 5 parts by mass or more and 100 parts by mass or less.

The ratio of the colorant with respect to 100 parts by mass of the epoxy resin is, for example, 100 parts by mass or more, and preferably 130 parts by mass or more. The ratio of the colorant with respect to 100 parts by mass of the epoxy resin is, for example, 230 parts by mass or less, and preferably 200 parts by mass or less. The ratio of the colorant with respect to 100 parts by mass of the epoxy resin is, for example, 100 parts by mass or more and 230 parts by mass or less, and preferably 130 parts by mass or more and 200 parts by mass or less.

Note that, of the components contained in the first ink layer 36, a blending amount of a component which is supplied in a liquid form dissolved or dispersed in any solvent may be adjusted so that a ratio of an active component falls within the above range (the same being applied to the following).

The first ink layer 36 can be formed, for example, by applying, onto the front surface 38 of the base material layer 35 directly or through any release layer, a coating material obtained by dissolving or dispersing each of the above-described components in any solvent, and then drying the coating material. In the present disclosure, as illustrated in FIGS. 6A and 6B, the characters to be recorded on the printer tape 2 are color-coded. In order to perform this color-coding, it is preferable that the first ink layer 36 is directly formed on the front surface 38 of the base material layer 35 without the release layer, in consideration of adjustment of the adhesion between the first ink layer 36 and the base material layer 35 or each of other layers.

A thickness of the first ink layer 36 can be arbitrarily set according to, for example, specifications of a thermal transfer printer. The thickness of the first ink layer 36 can be adjusted by an application amount of the first ink layer 36.

For example, the application amount of the first ink layer 36 is 0.1 g/m² or more, and preferably 0.5 g/m² or more in terms of solid content per unit area. For example, the application amount of the first ink layer 36 is 3.0 g/m² or less, and preferably 2.5 g/m² or less in terms of solid content per unit area. For example, the application amount of the first ink layer 36 is 0.1 g/m² or more and 3.0 g/m² or less, and preferably 0.5 g/m² or more and 2.5 g/m² or less in terms of solid content per unit area.

The first ink layer 36 has a specific thickness (before printing) of, for example, 0.05 μm or more, and preferably 0.5 μm or more. The first ink layer 36 has a thickness of, for example, 3.0 μm or less, and preferably 2.5 μm or less. The first ink layer 36 has a thickness of, for example, 0.05 μm or more and 3.0 μm or less, and preferably 0.5 μm or more and 2.5 μm or less. The thickness of the first ink layer 36 can be checked based on, for example, a scanning electron microscope (SEM) image, a transmission electron microscope (TEM) image, or the like of the ink ribbon 3.

### (3) Middle Layer 51

The middle layer 51 contains thermoplastic elastomer. In particular, the middle layer 51 is preferably formed only by the thermoplastic elastomer. The thermoplastic elastomer forming the middle layer 51 preferably includes at least one of a styrene-based thermoplastic elastomer and an acetate ester-based thermoplastic elastomer.

Examples of the styrene-based thermoplastic elastomer include a styrene-butadiene-styrene block copolymer (SBS), a styrene-ethylene-butene-styrene block copolymer (SEBS), a styrene-ethylene-propylene-styrene block copolymer (SEPS), a styrene-ethylene/ethylene-propylene-styrene block copolymer (SEEPS), a styrene-isoprene-styrene block copolymer (SIS), and the like. Examples of the acetate ester-based thermoplastic elastomer include an ethylene-vinyl acetate copolymer (EVA) and the like.

A percentage styrene content in the thermoplastic elastomer included in the middle layer 51 is, for example, 10 mass % or more and 70 mass % or less, and preferably 15 mass % or more and 50 mass % or less. If the percentage styrene content is too high, the rubber-like elasticity of the middle layer 51 decreases, and there is a case where it is not possible to maintain the adhesion to the first ink layer 36 and the second ink layer 37 at the time of low-temperature transfer, or a case where the color tones of the characters become dusky. If the percentage styrene content is too low, the rubber-like elasticity of the middle layer 51 increases too high, so that it is not possible for the second ink layer 37 to be peeled off at the time of high-temperature transfer, and the colors of the character may become dusky.

The thermoplastic elastomer included in the middle layer 51 has a Melt Mass-Flow Rate (hereinafter simply abbreviated as “MFR”) of, for example, 1000 g/10 min or less, and preferably 400 g/10 min or less. The MFR may be, for example, an MFR at a temperature of 190° C. and under a load of 2.16 kg, which is determined in accordance with a measurement method defined in ISO 1133-1:2011. Hereinafter, unless conditions for measuring the MFR are otherwise specified, the conditions are a temperature of 190° C. and a load of 2.16 kg.

The thermoplastic elastomer having an MFR of more than 400 g/10 min tends to have too high affinity with the second ink layer 37. Therefore, there is a case where it is not possible to peel the second ink layer 37 at the time of high-temperature transfer, and the colors of the characters become dusky. Also, the entire ink ribbon 3, that is, the base material layer 35, the first ink layer 36, the middle layer 51, and the second ink layer 37 may be attached to the printing surface 31 of the printer tape 2. A thermoplastic elastomer having an MFR of more than 400 g/10 min has a low melt viscosity and high fluidity, and thus may fail to maintain the adhesion to the first ink layer 36 and the second ink layer 37 at the time of low-temperature transfer, or may result in dusky color tone of the characters.

In this respect, when the thermoplastic elastomer has an MFR of 400 g/10 min or less, it is possible to prevent problems that may arise when the thermoplastic elastomer having an MFR exceeding 400 g/10 min is used. Accordingly, even if the thermal transfer recording is continuously performed, the color tones do not easily become dusky and are clearly separated into two colors on the printing surface 31 of the printer tape 2, and furthermore, the characters can be recorded stably with excellent sharpness without extra peeling. In consideration of further improving these effects, the MFR of the thermoplastic elastomer is preferably 2.5 g/10 min or less, and particularly 2.3 g/10 min or less even within the above range.

The lower limit of the MFR is not particularly limited, and thermoplastic elastomers having a measurement result of “No Flow (not flowing)” at a temperature of 190° C. under a load of 2.16 kg can also be used. Specific examples of the thermoplastic elastomers are not particularly limited, and include the following various thermoplastic elastomers. These thermoplastic elastomers can be used individually or in combination of two or more kinds thereof.

Among the TUFTEC (registered trademark) series of SEBS manufactured by Asahi Kasei Co., Ltd., H1521 [MFR: 2.3 g/10 min], H1051 [MFR: less than 0.8 g/10 min], H1052 [MFR: less than 13.0 g/10 min], H1272 [MFR: No Flow], P1083 [MFR: 3.0 g/10 min], P1500 [MFR: 4.0 g/10 min], P5051 [MFR: 3.0 g/10 min], and P2000 [MFR: 3.0 g/10 min].

Among the TUFPRENE (registered trademark) series of SBS manufactured by Asahi Kasei Co., Ltd., A [MFR: 2.6 g/10 min], 125 [MFR: 4.5 g/10 min], and 126S [MFR: 4.5 g/10 min].

Among the ASAPRENE (registered trademark) T series of SBS manufactured by Asahi Kasei Co., Ltd., T-411 [MFR: No Flow], T-432 [MFR: No Flow], T-437 [MFR: No Flow], T-438 [MFR: No Flow], and T-439 [MFR: No Flow].

Among the SEPTON (registered trademark) series of SEPS manufactured by KURARAY CO., LTD., 2002 [MFR: 70 g/10 min], 2004F [MFR: 5 g/10 min], 2005 [MFR: No Flow], 2006 [MFR: No Flow], 2063 [MFR: 7 g/10 min], and 2104 [MFR: 0.4 g/10 min]. The measurement conditions of the MFR of all of these SEPS are at a temperature of 230° C. and under a load of 2.16 kg.

Among the SEPTON (registered trademark) series of SEEPS manufactured by KURARAY CO., LTD., 4033 [MFR: <0.1 g/10 min], 4044 [MFR: No Flow], 4055 [MFR: No Flow], 4077 [MFR: No Flow], and 4099 [MFR: No Flow]. The measurement conditions of the MFR of all of these SEEPS are at a temperature of 230° C. and under a load of 2.16 kg.

Among the HYBRAR (registered trademark) series of vinyl SIS manufactured by KURARAY CO., LTD., 5125 [MFR: 4 g/10 min] and 5127 [MFR: 5/10 min].

Among the ULTRATHENE (registered trademark) series of EVA manufactured by Tosoh Corporation., 514R [MFR: 0.41 g/10 min], 515 [MFR: 2.5 g/10 min], 510 [MFR: 2.5 g/10 min], 510F [MFR: 2.5 g/10 min], 520F [MFR: 2.0 g/10 min], 540 [MFR: 3.0 g/10 min], 540F [MFR: 3.0 g/10 min], 537 [MFR: 8.5 g/10 min], 537L [MFR: 8.5 g/10 min], 537S-2 [MFR: 8.5 g/10 min], 541 [MFR: 9.0 g/10 min], 541L [MFR: 9.0 g/10 min], 530 [MFR: 75 g/10 min], 526 [MFR: 25 g/10 min], 630 [MFR: 1.5 g/10 min], 631 [MFR: 1.5 g/10 min], 636 [MFR: 2.5 g/10 min], 625 [MFR: 14 g/10 min], 626 [MFR: 3.0 g/10 min], 627 [MFR: 0.8 g/10 min], 633 [MFR: 20 g/10 min], 635 [MFR: 2.4 g/10 min], 640 [MFR: 2.8 g/10 min], 634 [MFR: 4.3 g/10 min], 680 [MFR: 160 g/10 min], 681 [MFR: 350 g/10 min], 751 [MFR: 5.7 g/10 min], 710 [MFR: 18 g/10 min], 720 [MFR: 150 g/10 min], 722 [MFR: 400 g/10 min], 750 [MFR: 30 g/10 min], 752 [MFR: 60 g/10 min], and 760 [MFR: 70 g/10 min].

The middle layer 51 can be formed, for example, by applying, on the first ink layer 36, a coating material obtained by dissolving or dispersing a forming material for the middle layer 51 including at least a thermoplastic elastomer in any solvent, and then drying the coating material.

A thickness of the middle layer 51 can be arbitrarily set according to, for example, specifications of the thermal transfer printer. The thickness of the middle layer 51 can be adjusted by an application amount of the middle layer 51. For example, the application amount of the middle layer 51 is 0.1 g/m² or more, and preferably 0.2 g/m² or more in terms of a solid content per unit area. For example, the application amount of the middle layer 51 is 2.0 g/m² or less, and preferably 1.5 g/m² or less in terms of a solid content per unit area. For example, the application amount of the middle layer 51 is 0.1 g/m² or more and 2.0 g/m² or less, and preferably 0.2 g/m² or more and 1.5 g/m² or less in terms of solid content per unit area.

A specific thickness of the middle layer 51 (before printing) is, for example, 0.05 μm or more, and preferably 0.2 μm or more. The thickness of the middle layer 51 is, for example, 2.0 μm or less, and preferably 1.5 μm or less. The thickness of the middle layer 51 is, for example, 0.05 μm or more and 2.0 μm or less, and may be preferably 0.2 μm or more and 1.5 μm or less. The thickness of the middle layer 51 can be checked based on, for example, a scanning electron microscope (SEM) image, a transmission electron microscope (TEM) image, or the like of the ink ribbon 3.

Note that an error in the thickness of the middle layer 51 may be found depending on a measurement position due to the application accuracy limit. The application amount and the thickness of the middle layer 51 may be values including the error. For example, the middle layer 51 formed with an application amount of 0.2 g/m² may have a region having a thickness in a case of forming the middle layer with an application amount of 0.1 g/m² depending on the measurement position.

### (4) Second Ink Layer 37

The second ink layer 37 can be made of, for example, any thermoplastic resin. Examples of the thermoplastic resin used for the second ink layer 37 include an epoxy resin, a polyester resin, a polyolefin resin, and the like. The thermoplastic resin can be appropriately selected according to a forming material or the like for the printer tape 2. In a case where the first ink layer 36 is made of the epoxy resin, it is preferable that the second ink layer 37 is also made of the epoxy resin similarly.

The adhesion of the first ink layer 36 to the base material layer 35 and the middle layer 51 and the adhesion of the second ink layer 37 to the printer tape 2 can be balanced by making the second ink layer 37 of the epoxy resin. Consequently, at the time of high-temperature transfer, both first ink layer 36 and the middle layer 51 can be favorably separated toward the base material layer 35 side, and the second ink layer 37 can be favorably separated toward the printer tape 2 side. Since the high-temperature transfer range can be widened to the low temperature side, the effect of preventing the color tone from becoming dusky can be further improved. Examples of the epoxy resin include various epoxy resins exemplified as the epoxy resin of the first ink layer 36. These epoxy resins can be used individually or in combination of two or more kinds thereof.

The second ink layer 37 may contain wax in addition to the thermoplastic resin. By containing the wax, it is made possible to favorably separate both the first ink layer 36 and the middle layer 51 toward the base material layer 35 side and favorably separate the second ink layer 37 toward the printer tape 2 side at the time of high-temperature transfer. Therefore, since the high-temperature transfer range can be widened to the low temperature side, the effect of preventing the color tone from becoming dusky can be further improved.

As the wax, any wax having affinity with or compatibility with a thermoplastic resin such as an epoxy resin can be used. For example, natural wax such as carnauba wax, paraffin wax, and microcrystalline wax, and synthetic wax such as Fischer Tropsch wax can be used. Specific examples of the wax are not particularly limited, and include carnauba wax No. 1 flake, No. 2 Flake, No. 3 Flake, No. 1 Powder and No. 2 Powder (melting points of all the products: 80 to 86° C.) manufactured by TOYOCHEM CO., LTD., EMUSTAR-1155 (melting point: 69° C.), EMUSTAR-0135 (melting point: 60° C.), EMUSTAR-0136 (melting point: 60° C.) and the like which are paraffin wax products manufactured by NIPPON SEIRO CO., LTD., EMUSTAR-0001 (melting point: 84° C.), EMUSTAR-042X (melting point: 84° C.) and the like which are microcrystalline wax products manufactured by NIPPON SEIRO CO., LTD., FNP-0090 (condensation point: 90° C.), SX80 (condensation point: 83° C.), FT-0165 (melting point: 73° C.), FT-0070 (melting point: 72° C.), and the like which are Fischer Tropsch wax products manufactured by NIPPON SEIRO CO., LTD. These wax products can be used individually or in combination of two or more kinds thereof.

The second ink layer 37 may contain any colorant. As the colorant, one or more kinds of various colorants corresponding to the color tone of the second ink layer 37 can be used. For example, pigments or dyes may be used as the colorants. From the viewpoint of securing transparency to the first ink layer 36, the second ink layer 37 preferably contains colorant that at least contains dye. The second ink layer 37 preferably contains only dye as colorant, but may contain dye and pigment in a ratio smaller than that of the dye. Details of the colorant of the second ink layer 37 will be described below.

Here, the second ink layer 37 that ensures transparency to the first ink layer 36 may be defined, for example, as having translucency with which the printing pattern 44 of the first transfer layer 57 can be visually recognized as the color of the first ink layer 36 when the printing pattern 44 is viewed from the second ink layer 37 side. Accordingly, when the transfer-completed tape 55 is viewed in the direction indicated by the open arrow 59 in FIG. 5A, the printing pattern 44 is recognized as the color of the first ink layer 36. As a numerical value that represents the transparency of the second ink layer 37, a total light transmittance, for example, may be used that is measured in conformity with JIS K 7361. The second ink layer 37 may have a total light transmittance of, for example, 16% or more, and preferably 16.5% or more. The total light transmittance of the second ink layer 37 can be measured using, for example, a haze meter.

When a combination of dye and pigment is used, the mixing ratio (mass ratio) of the dye is, for example, 50 mass % or more, preferably 70 mass % or more, and more preferably 90 mass % or more. As the mass ratio of the dye increases, the transparency of the second ink layer 37 to the first ink layer 36 can be improved.

Also, the color difference of reflected light from the second ink layer 37 has an L value of 20 or less, preferably 15 or less, more preferably 10 or less, and particularly preferably 5 or less. The L value may be, for example, a reflection density (L value) measured using a reflection color difference meter upon incidence of a light flux from the second ink layer 37 side of the ink ribbon 3. The transparency to the first ink layer 36 can be ensured sufficiently as long as the L value of reflected light from the second ink layer 37 is within the above range.

Ratios of components in the second ink layer 37 are not particularly limited. A ratio of the wax with respect to 100 parts by mass of the epoxy resin is, for example, 3 parts by mass or more, and preferably 5 parts by mass or more. The ratio of the wax with respect to 100 parts by mass of the epoxy resin is, for example, 11 parts by mass or less, and preferably 9 parts by mass or less. The ratio of the wax with respect to 100 parts by mass of the epoxy resin is, for example, 3 parts by mass or more and 11 parts by mass or less, and preferably 5 parts by mass or more and 9 parts by mass or less.

The ratio of the colorant (the total amount of the colorant) with respect to 100 parts by mass of the epoxy resin is, for example, 70 parts by mass or more, and preferably 80 parts by mass or more. The ratio of the colorant with respect to 100 parts by mass of the epoxy resin is, for example, 140 parts by mass or less, and preferably 120 parts by mass or less. The ratio of the colorant with respect to 100 parts by mass of the epoxy resin is, for example, 70 parts by mass or more and 140 parts by mass or less, and preferably 80 parts by mass or more and 120 parts by mass or less.

The second ink layer 37 can be formed, for example, by applying, on the middle layer 51, a coating material obtained by dissolving or dispersing the above components in any solvent and then drying the coating material.

A thickness of the second ink layer 37 can be arbitrarily set according to, for example, specifications of a thermal transfer printer. The thickness of the second ink layer 37 can be adjusted by an application amount of the second ink layer 37. For example, the application amount of the second ink layer 37 is 0.2 g/m² or more, and preferably 1.0 g/m² or more in terms of solid content per unit area. For example, the application amount of the second ink layer 37 is 7.0 g/m² or less, and preferably 5.0 g/m² or less in terms of solid content per unit area. For example, the application amount of the second ink layer 37 is 0.2 g/m² or more and 7.0 g/m² or less, preferably 1.0 g/m² or more and 5.0 g/m² or less in terms of solid content per unit area.

A specific thickness of the second ink layer 37 (before printing) is, for example, 0.05 μm or more, and preferably 1.0 μm or more. The thickness of the second ink layer 37 is, for example, 7.0 μm or less, and preferably 5.0 μm or less. The thickness of the second ink layer 37 is, for example, 0.05 μm or more and 7.0 μm or less, and preferably 1.0 μm or more and 5.0 μm or less. The thickness of the second ink layer 37 can be checked based on, for example, a scanning electron microscope (SEM) image, a transmission electron microscope (TEM) image, or the like of the ink ribbon 3.

### (5) Colorants in First Ink Layer 36 and Second Ink Layer 37

As indicated by the open arrows 59, 60 in FIGS. 5A and 5B, in the transfer-completed tape 55 of the disclosure, the color of each of the first ink layer 36 and the second ink layer 37 is recognized via light transmitted through the printer tape 2 and reflected at the first ink layer 36 or the second ink layer 37. Since the color of the first ink layer 36, which is on the back surface side, is recognized via light transmitted through the second ink layer 37, the actually recognized color of the first ink layer 36 may be different from an ideal color that is desired to be recognized as the color of the first ink layer 36.

Then, in the preferred embodiment of the disclosure, the first ink layer 36 and the second ink layer 37 contain colorants that are in a complementary color relationship with each other to bring the color recognized for the first ink layer 36 closer to the ideal color. The “complementary color relationship” may be, for example, a relationship between a reference color selected in a hue circle of 24 colors and a color having a hue difference of 11 to 12 with respect to the reference color. In other words, the “complementary color relationship” may be a relationship between a reference color and a color at a position of 1650 to 195° from the reference color in the hue circle.

Since complementary colors become an achromatic color when mixed, the “complementary color relationship” in this preferred embodiment may be a combination of the colors of the first ink layer 36 and the second ink layer 37 which provides the color difference of reflected light from the second ink layer 37 has an L value of 20 or less.

For example, when black and an achromatic color close to black are required for the first ink layer, various combinations can be exemplified as follows. For example, when the second ink layer 37 is red, the first ink layer 36 is preferably blue-green, which is a complementary color of red. For example, when the second ink layer 37 is violet, the first ink layer 36 is preferably yellow-green, which is a complementary color of violet. For example, when the second ink layer 37 is yellow, the first ink layer 36 is preferably blue-violet, which is a complementary color of yellow. For example, when the second ink layer 37 is orange, the first ink layer 36 is preferably blue, which is a complementary color of orange.

Examples of the dye for coloring the second ink layer 37 red include oil-soluble dye, acid dye, basic dye, and gold-containing dye, and various salt forming types of dye thereof, etc., and the following various types of red dye. These red dyes can be used individually or in combination of two or more kinds thereof.

C.I. Basic Red 1, 12, 13, C.I. Acid Red 13, 14, 18, 27, 50, 52, C.I. Solvent Red 25, 27, 30, 35, 49, 83, 89, 100, 122, 138, 149, 150, 160, 179, 218, 230, C.I. Direct Red 20, 37, 39, 44, C.I. Disperse Red 5, 7, 13, 17.

Examples of the pigments for coloring the second ink layer 37 red include the following various red pigments. These red pigments can be used individually or in combination of two or more kinds thereof.

C.I. Pigment Red 5, 7, 9, 12, 48 (Ca), 48 (Mn), 49, 52, 53, 53:1, 57 (Ca), 57:1, 97, 112, 122, 123, 149, 168, 177, 178, 179, 184, 202, 206, 207, 209, 242, 254, 255.

Examples of the pigment for coloring the first ink layer 36 blue-green as a complementary color of the second ink layer 37 (red) include the following various types of green pigment. These green pigments can be used individually or in combination of two or more kinds thereof.

C.I. Pigment Green 7, 10, 36, 37, 58, 59, 62, 63.

Examples of the dye for coloring the second ink layer 37 violet include oil-soluble dye, acid dye, basic dye, gold-containing dye, and various salt forming types of dye thereof, etc., and the following various types of violet dye. These violet dyes can be used individually or in combination of two or more kinds thereof.

C. I. Basic Violet 1, 3, 7, 10, 14, 15, 21, 25, 26, 27, 28; C.I. Acid Violet 1, 2, 3, 4, 5, 5:1, 6, 7, 7:1, 9, 11, 12, 13, 14, 15, 16, 17, 19, 20, 21, 23, 24, 25, 27, 29, 30, 31, 33, 34, 36, 38, 39, 41, 42, 43, 47, 49, 51, 63, 67, 72, 76, 96, 97, 102, 103, 109.

Examples of the pigment for coloring the second ink layer 37 violet include the following various types of violet pigment. These violet pigments can be used individually or in combination of two or more kinds thereof.

C.I. Pigment Violet 1, 19, 27, 29, 30, 32, 37, 40, 42, 50.

Examples of the pigment for coloring the first ink layer 36 into yellow-green as a complementary color of the second ink layer 37 (violet) include a mixture of the above-mentioned green pigments and the following various types of yellow pigment. These green pigments and yellow pigments can be used individually or in combination of two or more kinds thereof. The mixing proportion of the green pigment and the yellow pigment may be 5:5.

C. I. Pigment Yellow 1, 2, 3, 4, 5, 6, 10, 12, 13, 14, 15, 16, 17, 18, 20, 24, 31, 32, 34, 35, 35:1, 36, 36:1, 37, 37:1, 40, 42, 43, 53, 55, 60, 61, 62, 63, 65, 73, 74, 77, 81, 83, 86, 93, 94, 95, 97, 98, 100, 101, 104, 106, 108, 109, 110, 113, 114, 115, 116, 117, 118, 119, 120, 123, 125, 126, 127, 128, 129, 137, 138, 147, 148, 150, 151, 152, 153, 154, 155, 156, 161, 162, 164, 166, 167, 168, 169, 170, 171, 172, 173, 174, 175, 176, 177, 179, 180, 181, 182, 185, 187, 188, 193, 194, 198, 199, 213, 214, 218, 219, 220, 221, 231, 233.

Examples of the dye for coloring the second ink layer 37 yellow include oil-soluble dye, acid dye, basic dye, gold-containing dye, and various salt forming types of dye thereof, etc., and the following various types of yellow dye. These yellow dyes can be used individually or in combination of two or more kinds thereof.

C.I. Acid Yellow 2, 3, 4, 5, 6, 7, 8, 9, 9:1, 10, 11, 11:1, 12, 13, 14, 15, 16, 17, 17:1, 18, 20, 21, 22, 23, 25, 26, 27, 29, 30, 31, 33, 34, 36, 38, 39, 40, 40:1, 41, 42, 42:1, 43, 44, 46, 48, 51, 53, 55, 56, 60, 63, 65, 66, 67, 68, 69, 72, 76, 82, 83, 84, 86, 87, 90, 94, 105, 115, 117, 122, 127, 131, 132, 136, 141, 142, 143, 144, 145, 146, 149, 153, 159, 166, 168, 169, 172, 174, 175, 178, 180, 183, 187, 188, 189, 190, 191, 192, 199.

Examples of the pigment for coloring the second ink layer 37 yellow include the above-mentioned various types of yellow pigment. These yellow pigments can be used individually or in combination of two or more kinds thereof.

Examples of the pigment for coloring the first ink layer 36 blue-violet as a complementary color of the second ink layer 37 (yellow) include a mixture of the following types of blue pigment and the above-mentioned violet pigments. These blue pigments and violet pigments can be used individually or in combination of two or more kinds thereof. The mixing proportion of the blue pigment and the violet pigment may be 5:5.

C.I. Pigment Blue 15:3, 15:4, 15:6.

Examples of the dye for coloring the second ink layer 37 orange include oil-soluble dye, acid dye, basic dye, gold-containing dye, and various salt forming types of dye thereof, etc., and the following various types of orange dye. These orange dyes can be used individually or in combination of two or more kinds thereof.

C.I. Acid Orange 1, 1:1, 4, 5, 6, 7, 8, 9, 10, 12, 14, 16, 17, 18, 19, 20, 20:1, 22, 23, 24, 24:1, 25, 27, 28, 28:1, 30, 31, 33, 35, 36, 37, 38, 41, 45, 49, 50, 51, 54, 55, 56, 59, 79, 83, 94, 95, 102, 106, 116, 117, 119, 128, 131, 132, 134, 136, 138.

Examples of the pigment for coloring the second ink layer 37 orange include the following various types of orange pigment. These orange pigments can be used individually or in combination of two or more kinds thereof. C.I. Pigment Orange 36, 38, 43, 51, 55, 59, 61, 71, 73.

Examples of the pigment for coloring the first ink layer 36 blue as a complementary color of the second ink layer 37 (orange) include the above-mentioned blue pigments.

The sticking tape 76 includes a base material layer 61, a first adhesive layer 62, a second adhesive layer 63, and a peel-off layer 64. The first adhesive layer 62 is formed on an adhesive surface 65 of the base material layer 61, and the second adhesive layer 63 is formed on a peel-off surface 66 on the opposite side of the adhesive surface 65. The sticking tape 76 is stuck to the print product 56 via the first adhesive layer 62.

### (6) Base Material Layer 61

Examples of the base material layer 61 include a film of a resin such as polysulfone, polystyrene, polyamide, polyimide, polycarbonate, polypropylene, polyester, or triacetate, condenser paper, tissue paper such as glassine paper, cellophane, and the like. Of these materials, a film of polyester such as polyethylene terephthalate (PET) or polyethylene naphthalate is preferable from the viewpoint of mechanical strength, dimensional stability, heat treatment resistance, price, or the like. A thickness of the base material layer 61 can be arbitrarily set according to, for example, specifications of a thermal transfer printer. For example, the thickness of the base material layer 61 is 1 μm or more, and preferably 10 μm or more. For example, the thickness of the base material layer 61 is 100 μm or less, and preferably 50 μm or less. For example, the thickness of the base material layer 61 is 1 μm or more and 100 μm or less, and preferably 10 μm or more and 50 μm or less.

### (7) First Adhesive Layer 62

The first adhesive layer 62 is not particularly limited as long as it is an adhesive layer used for adhesion between films, and examples thereof include acrylic adhesive and rubber-based adhesive. For example, the thickness of the first adhesive layer 62 is 1 μm or more, and preferably 10 μm or more. For example, the thickness of the first adhesive layer 62 is 100 μm or less, and preferably 50 μm or less. For example, the thickness of the first adhesive layer 62 is 1 μm or more and 100 μm or less, and preferably 10 μm or more and 50 μm or less.

### (8) Second Adhesive Layer 63

The second adhesive layer 63 is not particularly limited as long as it is an adhesive layer used for adhesion between films, and such adhesive material as used in the first adhesive layer 62, for example, can be used. For example, the thickness of the second adhesive layer 63 is 1 μm or more, and preferably 10 μm or more. For example, the thickness of the second adhesive layer 63 is 100 μm or less, and preferably 50 μm or less. For example, the thickness of the second adhesive layer 63 is 1 μm or more and 100 μm or less, and preferably 10 μm or more and 50 μm or less.

### (9) Peel-Off Layer 64

When the transfer-completed tape 55 is to be stuck to a target object, the peel-off layer 64 is peeled off from the sticking tape 76 and exposes the second adhesive layer 63. The transfer-completed tape 55 can be stuck to the target object via the exposed second adhesive layer 63. Examples of the peel-off layer 64 include peel-off paper coated with peeling agent such as silicone.

It is noted that as illustrated in FIGS. 5C and 5D, the sticking tape 76 may not include the base material layer 61.

In accordance with the transfer-completed tape 55 that includes the above-described layer configuration, the second ink layer 37 has translucency that allows for visual recognition of the first ink layer 36. This makes it possible to form a film in which a laminated body of the first ink layer 36 and the second ink layer 37 is transferred to the transparent printer tape 2 such that the second ink layer 37 serves as a front surface side ink layer (observation surface side ink layer). Since the second ink layer 37 has translucency that allows for visual recognition of the first ink layer 36, the color of the first ink layer 36 can be recognized through the second ink layer 37 in the transfer-completed tape 55. Further, the second ink layer 37 has a complementary color relationship with the first ink layer 36. It is therefore possible to bring the color of the first ink layer 36 visually recognized through the second ink layer 37 close to an ideal color (in this preferred embodiment, black or an achromatic color close to black) even when the first ink layer 36 is covered with the second ink layer 37.

As described above, the above-described preferred embodiment of the present disclosure is illustrative in all respects and should not be construed as limiting, and is intended to include modifications in all respects.

From the description herein and the drawings, the following appended features may be extracted.

### Appendix 1-1

A thermal transfer recording medium to be transferred to a transparent film, including:
a base material layer; and
a first ink layer and a second ink layer that are sequentially laminated on the base material layer, in which the second ink layer has translucency that allows for visual recognition of the first ink layer, and has a complementary color relationship with the first ink layer.

### Appendix 1-2

The thermal transfer recording medium according to appendix 1-1, in which the color difference of reflected light from the second ink layer has an L value of 20 or less.

### Appendix 1-3

The thermal transfer recording medium according to appendix 1-1 or 1-2, in which the second ink layer includes 50 mass % or more of a dye as a color material.

### Appendix 1-4

The thermal transfer recording medium according to any one of appendices 1-1 to 1-3, in which the first ink layer contains thermoplastic resin and adhesive.

### Appendix 1-5

The thermal transfer recording medium according to any one of appendices 1-1 to 1-4, in which the second ink layer contains thermoplastic resin and wax.

### Appendix 1-6

The thermal transfer recording medium according to any one of appendices 1-1 to 1-5, further including a middle layer that is formed between the first ink layer and the second ink layer.

### Appendix 1-7

The thermal transfer recording medium according to appendix 1-6, in which the middle layer contains styrene-based thermoplastic elastomer.

### Appendix 1-8

A transfer-completed film with a first ink layer, a second ink layer having translucency that allows for visual recognition of the first ink layer, and a transparent film laminated in this order, in which

the second ink layer has a complementary color relationship with the first ink layer.

### Appendix 1-9

The transfer-completed film according to appendix 1-8, including:
a print product that includes a laminated body of the transparent film, the first ink layer, and the second ink layer; and
a stick layer that includes a first adhesive layer laminated on the print product on the first ink layer side and the base material layer stuck to the print product with the first adhesive layer therebetween.

### Appendix 1-10

The transfer-completed film according to appendix 1-9, in which the stick layer further includes a second adhesive layer laminated on the base material layer on a side opposite to the first adhesive layer and a peel-off layer laminated on the base material layer with the second adhesive layer therebetween.

### Appendix 1-11

A method of producing a transfer-completed film, including:

a heating step of heating a thermal transfer recording medium that has a base material layer and a laminated body of a first ink layer and a second ink layer sequentially laminated on the base material layer, in which the second ink layer has translucency that allows for visual recognition of the first ink layer, and the second ink layer has a complementary color relationship with the first ink layer, in a state where the second ink layer is in contact with the transparent film;
a cooling step of cooling the thermal transfer recording medium that has been heated in the heating step; and a transferring step of transferring a transfer layer that includes at least the laminated body of the first ink layer and the second ink layer to the transparent film by applying an external force to the base material layer and the first ink layer of the thermal transfer recording medium that has been cooled in the cooling step in a direction in which the layers are separated from each other.

### Appendix 1-12

The transfer-completed film producing method according to appendix 1-11, in which
in the heating step, a first portion of the thermal transfer recording medium is heated through application of relatively low first energy and a second portion of the thermal transfer recording medium is heated through application of second energy that is relatively higher than the first energy, and
in the transferring step, the laminated body of the first ink layer and the second ink layer is transferred to the transparent film in the first portion of the thermal transfer recording medium and the second ink layer is selectively transferred to the transparent film in the second portion of the thermal transfer recording medium.

### EXAMPLES

Hereinafter, the present disclosure will be further described based on a plurality of samples, but the configuration of the present disclosure is not limited to these examples.

### [Coating Material (1) for Green Colored Layer]

Epoxy resin: 100 parts by mass of JER1007 [Basic solid type, softening point (ring and ball method): 128° C., number average molecular weight Mn: about 2900] produced by Mitsubishi Chemical Corporation, Acrylic adhesive: 200 parts by mass of AS-665 [solid content concentration: 40% by mass] produced by Lion Specialty Chemicals Co., Ltd., Tackifier: 28.3 parts by mass of Terpene phenol resin, YS POLYSTER T80 (softening point: 80±5° C.) produced by YASUHARA CHEMICAL Co., Ltd., and 166.7 parts by mass of green colorant [Green pigment FASTOGEN (registered trademark) GREEN 5740 (C.I. Pigment Green 7) produced by DIC Corporation] were dissolved in a solvent of toluene and methyl ethyl ketone (MEK) mixed at a mass ratio of 1/4 to prepare a layer coating material (1) for the green-based colored having a solid content concentration of 22.5 mass %. A ratio of the active component in the acrylic adhesive was 80 parts by mass with respect to 100 parts by mass of the epoxy resin.

### [Coating Material (2) for Green Colored Layer]

A coating material (2) for the green colored layer was prepared in the same manner as the coating material (1) for the green colored layer except that the acrylic adhesive and the tackifier were not blended.

### [Coating Material (1) for Yellow-Green Colored Layer]

A coating material for the yellow-green colored layer (1) was prepared in the same manner as the coating material (1) for the green colored layer except that a mixture of green pigment [Green pigment FASTOGEN (registered trademark) GREEN 5740 (C.I. Pigment Green 7) produced by DIC Corporation] and yellow pigment [SYMULER (registered trademark) FAST YELLOWGF CONC-P (C.I. Pigment Yellow 12) produced by DIC Corporation](blending ratio=green pigment yellow pigment 5) was blended as the green-based colorant. The solid content concentration was 28 mass %.

The material names and blending ratios of the coating materials (1) to (2) for the green colored layer and the coating material (1) for the yellow-green colored layer as the coating material for the green-based colored layer are summarized in Table 1 below.

TABLE 1

| | | | | | Yellow- |
|---|---|---|---|---|---|
| | | | Green | Green | green |
| | | | colored | colored | colored |
| | | | layer 1 | layer 2 | layer 1 |
| Epoxy resin | | | 100 | ← | ← |
| Acrylic adhesive | | | 200 | — | 200 |
| Tackifier | | | 28.3 | — | 28.3 |
| Green-based colorant | | | 166.7 | ← | ← |
| | Colorant | Green dye | 10 | 10 | 5 |
| | blending | Green | 0 | 0 | 5 |
| | ratio | pigment | | | |

### [Coating Material (1) for Middle Layer]

A thermoplastic elastomer [TUFTEC H1521, SEBS, MFR: 12.3 g/10 min, 18 mass % of percentage styrene content, manufactured by Asahi Kasei Corporation] was dissolved in a mixed solvent of toluene and hexane at a mass ratio of 1/1 to prepare a coating material (1) for the middle layer having a solid content concentration of 10 mass %.

### [Coating Material (2) for Middle Layer]

A coating material (2) for the middle layer was prepared in the same manner as the coating material (1) for the middle layer, except that the same amount of TUFTEC H1517 [SEBS, MFR: less than 3.0 g/10 min, 43 mass % of percentage styrene content] manufactured by Asahi Kasei Corporation was blended as the thermoplastic elastomer. The solid content concentration was 10 mass %.

### [Coating Material (3) for Middle Layer]

A coating material (3) for the middle layer was prepared in the same manner as the coating material (1) for the middle layer, except that the same amount of TUFTEC H1272 [SEBS, MFR: No Flow, 35 mass % of percentage styrene content] manufactured by Asahi Kasei Corporation was blended as the thermoplastic elastomer. The solid content concentration was 10 mass %.

### [Coating Material (4) for Middle Layer]

A coating material (4) for the middle layer was prepared in the same manner as the coating material (1) for the middle layer, except that the same amount of TUFPRENE A [SBS, MFR: 2.6 g/10 min, 40 mass % of percentage styrene content] manufactured by Asahi Kasei Corporation was blended as the thermoplastic elastomer. The solid content concentration was 10 mass %.

### [Coating Material (5) for Middle Layer]

A coating material (5) for the middle layer was prepared in the same manner as the coating material (1) for the middle layer, except that the same amount of ULTRATHENE 634 [EVA, MFR: 4.3 g/10 min] manufactured by Tosoh Corporation was blended as the thermoplastic elastomer. The solid content concentration was 10 mass %.

### [Coating Material (6) for Middle Layer]

A coating material (6) for the middle layer was prepared in the same manner as the coating material (1) for the middle layer, except that the same amount of ULTRATHENE 722 [EVA, MFR: 400 g/10 min] manufactured by Tosoh Corporation was blended as the thermoplastic elastomer. The solid content concentration was 10 mass %.

### [Coating Material (7) for Middle Layer]

An coating material (7) for the middle layer was prepared in the same manner as the coating material (1) for the middle layer, except that the same amount of ULTRATHENE 725 [EVA, MFR: 1000 g/10 min] manufactured by Tosoh Corporation was blended as the thermoplastic elastomer. The solid content concentration was 10 mass %.

### [Coating Material (8) for Middle Layer]

A coating material (8) for the middle layer was prepared in the same manner as the coating material (1) for the middle layer, except that the same amount of an amorphous polyester resin [VYLON (registered trademark) 200 manufactured by Toyobo Co., Ltd.] which is a thermoplastic resin was blended instead of the thermoplastic elastomer. The solid content concentration was 10 mass %.

Material names, MFR, and styrene contents of the coating materials (1) to 8 for the middle layer are listed as shown in Table 2 below. The blending ratio of the constituent components is omitted since any one of the coating materials (1) to (8) for the middle layer has a blending ratio of solid content/toluene/hexane=10/45/45.

### [Table 2]

TABLE 2

| | | | | Styrene |
|---|---|---|---|---|
| | | | MFR | content |
| | Material name | | (g/10 min) | (mass %) |
| Middle | TUFTEC H1521 | SEBS | 2.3 | 18 |
| layer 1 | | | | |
| Middle | TUFTEC H1517 | ↑ | <3.0 | 43 |
| layer 2 | | | | |
| Middle | TUFTEC H1272 | ↑ | No Flow | 35 |
| layer 3 | | | | |
| Middle | TUFPRENE A | SBS | 2.6 | 12 |
| layer 4 | | | | |
| Middle | ULTRATHENE | EVA | 4.3 | 67 |
| layer 5 | 634 | | | |
| Middle | ULTRATHENE | ↑ | 400 | 40 |
| layer 6 | 722 | | | |
| Middle | ULTRATHENE | ↑ | 1000 | — |
| layer 7 | 725 | | | |
| Middle | Byron 200 | Polyester | — | — |
| layer 8 | | resin | | |

### [Coating Material (1) for Red Colored Layer]

100 parts by mass of JER1004 [Basic solid type, softening point (ring and ball method): 97° C., number average molecular weight Mn: about 1650] produced by Mitsubishi Chemical Corporation], 7.1 parts by mass of low-melting-point wax [carnauba wax No. 2 powder (melting point: 80 to 86° C.) produced by TOYOCHEM CO., LTD.], and 92.9 parts by mass of red-based colorant [red dye VALIFAST RED1320 (Onium salt of C.I. BASIC RED 1 and azo dye) produced by Orient Chemical Industries Co., Ltd.] were dissolved in mixed solvent of toluene and MEK at a mass ratio of 1/4 to prepare a coating material (1) for the red colored layer having a solid content concentration of 28 mass %.

### [Coating Material (2) for Red Colored Layer]

A coating material (2) for the red colored layer was prepared in the same manner as the coating material (1) for the red colored layer except that a mixture of red dye [VALIFAST RED 1320 (Onium salt of C.I. BASIC RED 1 and azo dye) manufactured by Orient Chemical Industries Co., Ltd.] and red pigment [SYMULER (registered trademark) LAKE RED C CONC 210 (C.I. Pigment Red 53:1) manufactured by DIC Corporation](blending ratio=red dye 7:red pigment 3) was blended as the red-based colorant. The solid content concentration was 28 mass %.

### [Coating Material (3) for Red Colored Layer]

A coating material (3) for the red colored layer was prepared in the same manner as the coating material (1) for the red colored layer except that a mixture of red dye [VALIFAST RED 1320 (Onium salt of C.I. BASIC RED 1 and azo dye) manufactured by Orient Chemical Industries Co., Ltd.] and red pigment [SYMULER (registered trademark) LAKE RED C CONC 210 (C.I. Pigment Red 53:1) manufactured by DIC Corporation](blending ratio=red dye 5:red pigment 5) was blended as the red-based colorant. The solid content concentration was 28 mass %.

### [Coating Material (1) for Violet Colored Layer]

A coating material (1) for the violet colored layer was prepared in the same manner as the coating material (1) for the red colored layer except that violet dye [VALIFAST VIOLET 1704 (mixture of C.I. BASIC VIOLET 1 and C.I. Acid Yellow 36) produced by Orient Chemical Industries Co., Ltd.] was blended alone as the red-based colorant. The solid content concentration was 28 mass %.

The material names and blending ratios of the coating materials (1) to (3) for the red colored layer and the coating material (1) for the violet colored layer as the coating material for the red-based colored layer are summarized in Table 3 below.

### [Table 3]

TABLE 3

| | | Red | Red | Red | Violet |
|---|---|---|---|---|---|
| | | colored | colored | colored | colored |
| | | layer 1 | layer 2 | layer 3 | layer 1 |
| Epoxy resin | | 100 | ← | ← | ← |
| Wax | | 7.1 | ← | ← | ← |
| Red-based colorant | | 92.9 | ← | ← | ← |
| Colorant | Red dye | 10 | 7 | 5 | 0 |
| blending | Red | 0 | 3 | 5 | 0 |
| ratio | pigment | | | | |
| | Violet | 0 | 0 | 0 | 10 |
| | dye | | | | |

### [Samples 1 to 16]

### (1) Production of Ink Ribbon (Thermal Transfer Recording Medium)

First, a PET film having a thickness of 4.5 μm was prepared as a base material layer. Next, a back surface layer made of a silicone-based resin and having a solid content of 0.1 g/m² per unit area was formed on a surface (back surface) of the base material layer opposite to a front surface on which a transfer layer was to be formed. Next, any one of the coating materials for the green-based colored layer which was previously prepared was applied to the front surface of the base material layer and then dried to form a green-based colored layer having a solid content per unit area of 1.5 g/m². Next, any one of the coating materials for the middle layer which was previously prepared was applied to the green-based colored layer and then dried to form a middle layer having a solid content per unit area of 1 g/m² (sample 2 excluded). Next, any one of the coating materials for the red-based colored layer which was previously prepared was applied to the middle layer and then dried to form a red-based colored layer having a solid content per unit area of 2.5 g/m² and thereby produce an ink ribbon. Tables 4 to 6 below show the composition of each layer of ink ribbons obtained with samples 1 to 16.

### (2) Evaluation

### (2-1) Transmittance of Base Material Film

First, the total light transmittance of a transparent base material film to be used for production of a transfer-completed film was measured. Two types of base material films were used. One is a glossy-finished transparent PET film [LUMIRROR (registered trademark) #50-510 manufactured by Toray Industries, Inc.], and the other is a matte-finished transparent PET film [film obtained by sandblasting LUMIRROR (registered trademark) #50-510 manufactured by Toray Industries, Inc.]. In Tables 4 to 6, the former is represented as “PET” and the latter is represented as “matte PET.”

The transmittance of each base material film was measured using a haze meter (NDH 7000 manufactured by NIPPON DENSHOKU INDUSTRIES CO., LTD.), with a sample for evaluation prepared by cutting the film into a 30 mm². The results are shown in Tables 4 to 6.

### (2-2) Reflection Density

A white PET sheet having a thickness of 330 μm was laid, and an ink ribbon produced with each sample was placed thereon such that the base material layer is beneath the ink ribbon. Next, a light flux was made incident from the red-based colored layer side, and the reflection density (L value) was measured. The reflection density was measured using a reflection color difference meter (Spectro Photometer NF777 manufactured by Nippon Denshoku Industries Co., Ltd.). The results are shown in Tables 4 to 6.

### (2-3) Printing Transmissivity

The ink ribbon manufactured in each sample was slit into a ribbon shape having a predetermined width, wound in a roll shape, and set in a thermal transfer printer [Prototype Printer manufactured by BROTHER INDUSTRIES, LTD.]. Main specifications of the thermal transfer printer are as follows.

| <Resolution> | 300 dpi line thermal head | |
|---|---|---|
| <Resistance value of the heating body> | 1830 | Ω |
| <Transfer Load> | 30 | N/2 inch |
| <Transport speed> | 20 | mm/sec |
| <Peel-off distance> | 110 | mm |

Next, an energy value which was set in advance in the thermal transfer printer and applied to a thermal head was set to 100 (low temperature) under the environment of an outside temperature of 25° C. A solid image having a size of 70 mm² was then thermally transferred onto the surface of each transparent base material film shown in Tables 4 to 6 under the condition of a printing speed of 5 inch/sec. Consequently, a transfer-completed film was obtained with a laminated body of the red-based colored layer and the green-based colored layer formed as a transfer layer such that the red-based colored layer was on the base material film side.

Next, the printing transmittivity of the transfer-completed film was evaluated. The printing transmissivity is an index for comparing the light transmissivity of the red-based colored layer that covers the green-based colored layer. The higher the evaluation of the printing transmissivity, the more likely the green-based colored layer can be recognized as black or an achromatic color close to black when viewed through the transparent base material film and the red-based colored layer. Specifically, a white PET sheet having a thickness of 330 μm was laid, and the transfer-completed film was placed thereon such that the transparent base material film is on top of the transfer-completed film. Next, a light flux was made incident from the transparent base material film side, and the reflection density (L value, a value and b value) was measured. The reflection density was measured using a reflection color difference meter (Spectro Photometer NF777 manufactured by Nippon Denshoku Industries Co., Ltd.). The printing transmissivity was evaluated according to the following criteria. The target value for each value of the reflection density that allows for recognition as black is L value ≤25, a value ≤17, and b value ≤7. The results are shown in Tables 4 to 6.
∘: It is recognized as black (the L value, the a value, and the b value are all within the target range).
Δ: Although some reddishness is contained, it is recognized as black (one or none of the L value, the a value, and the b value are outside the target range).
x: It is recognized as brown (two or more of the L value, the a value, and the b value are outside the target range).

### (2-4) Printing Stability

The ink ribbon manufactured in each sample was slit into a ribbon shape having a predetermined width, wound in a roll shape, and set in a thermal transfer printer that has the same specifications as in (2-3). Next, an energy value which was set in advance in the thermal transfer printer and applied to a thermal head was set to three levels of energy, respectively, on the lower temperature side and the higher temperature side under the environment of an outside temperature of 25° C. A solid image having a size of 70 mm² was then thermally transferred onto the surface of each transparent base material film shown in Tables 4 to 6 under the condition of a printing speed of 5 inch/sec.

Regarding the energy value to be applied to the thermal head, the lower temperature side has three levels in total, 100 as a reference value and 90 and 110 therearound. Consequently, a transfer-completed film was obtained with a laminated body of the red-based colored layer and the green-based colored layer formed as a transfer layer such that the red-based colored layer was on the base material film side. On the other hand, the higher temperature side has 3 levels in total, 170 as a reference value and 160 and 180 therearound. Consequently, a transfer-completed film was obtained with the red-based colored layer selectively peeled off from the base material layer and formed on the transparent base material film as a transfer layer.

Next, the printing stability of each transfer-completed film was evaluated. The printing stability is an index for comparing the width of the energy range that is required to form a desired transfer layer. The wider the energy range, the more stably a desired transfer layer can be achieved, thus the printing stability is high. Specifically, solid images transferred with the respective three levels of energy on the lower temperature side and the higher temperature side were compared to evaluate the printing stability according to the following criteria. The results are shown in Tables 4 to 6.
4: There is no change in any of the three levels, and the printable energy range is wide.
3: Dusky printing or non-printability exists in any one of the energy levels around the reference value.
2: Dusky printing or non-printability exists in any two of the energy levels around the reference value.
1: Dusky printing or non-printability exists in any three of the energy levels around the reference value.
0: Dusky printing or non-printability also exists in either the reference value energy 100 or 170.

### (2-5) Transmittance of Red-Based Colored Layer

The ink ribbon manufactured in each sample was slit into a ribbon shape having a predetermined width, wound in a roll shape, and set in a thermal transfer printer that has the same specifications as in (2-3). Next, an energy value which was set in advance in the thermal transfer printer and applied to a thermal head was set to 170 (high temperature) in an environment with an outside temperature of 25° C. A solid image having a size of 70 mm² was then thermally transferred onto the surface of each transparent base material film shown in Tables 4 to 6 under the condition of a printing speed of 5 inch/sec. Consequently, a transfer-completed film was obtained with the red-based colored layer selectively peeled off from the base material layer and formed on the transparent base material film as a transfer layer.

Next, the transmittance of each red-based colored layer was measured, with a sample for evaluation prepared by cutting each solid image into a 30 mm square. The transmittance was measured using a haze meter (NDH 7000 manufactured by Nippon Denshoku Industries Co., Ltd.). Specifically, first, the total light transmittance (%) of the sample for evaluation was measured. Similarly, the total light transmittance (%) of a blank (a non-printed portion of the transfer-completed film) was measured. Then, the formula: total light transmittance (%) of the sample for evaluation/total light transmittance (%) of the blank×100 was used to calculate the total light transmittance (%) of only the red-based colored layer. The results are shown in Tables 4 to 6.

TABLE 4

| | Sample | Sample | Sample | Sample | Sample | Sample |
|---|---|---|---|---|---|---|
| | 1 | 2 | 3 | 4 | 5 | 6 |
| Base material | PET | PET | PET | PET | Matte | Matte |
| film | | | | | PET | PET |
| Green-based | Green | Green | Green | Green | Green | Green |
| colored layer | colored | colored | colored | colored | colored | colored |
| | layer 1 | layer 1 | layer 1 | layer 1 | layer 2 | layer 2 |
| Middle layer | Middle | None | Middle | Middle | Middle | Middle |
| | layer 1 | | layer 1 | layer 1 | layer 1 | layer 1 |
| Red-based | Red | Red | Red | Red | Red | Red |
| colored layer | colored | colored | colored | colored | colored | colored |
| | layer 1 | layer 1 | layer 2 | layer 3 | layer 1 | layer 3 |
| Red dye:Red | 10:0 | 10:0 | 7:3 | 5:5 | 10:0 | 5:5 |
| pigment | | | | | | |
| Transmittance | 87 | 87 | 87 | 87 | 85 | 85 |
| of base | | | | | | |
| material film | | | | | | |
| (%) | | | | | | |
| L value | 4.5 | 4.5 | 13 | 20 | 4.5 | 20 |
| Printing | ∘ | ∘ | ∘ | Δ | ∘ | ∘ |
| transmissivity | | | | | | |
| Printing | 4 | 1 | 4 | 4 | 4 | 4 |
| stability | | | | | | |
| Red-based | 17.1 | 17.2 | 16.8 | 16.5 | 16.5 | 16 |
| print | | | | | | |
| transmittance | | | | | | |
| (%) | | | | | | |

TABLE 5

| | Sample | Sample | Sample | Sample | Sample |
|---|---|---|---|---|---|
| | 7 | 8 | 9 | 10 | 11 |
| Base material | Matte | PET | PET | PET | PET |
| film | PET | | | | |
| Green-based | Green | Yellow- | Yellow- | Green | Green |
| colored layer | colored | green | green | colored | colored |
| | layer 2 | colored | colored | layer 1 | layer 1 |
| | | layer 1 | layer 1 | | |
| Middle layer | Middle | Middle | Middle | Middle | Middle |
| | layer 1 | layer 1 | layer 1 | layer 2 | layer 3 |
| Red colored | Red | Red | Violet | Red | Red |
| layer | colored | colored | colored | colored | colored |
| | layer 1 | layer 1 | layer 1 | layer 1 | layer 1 |
| Red dye:Red | 10:0 | 10:0 | 10:0 | 10:0 | 10:0 |
| pigment | | | | | |
| Transmittance | 85 | 87 | 87 | 87 | 87 |
| of base | | | | | |
| material film | | | | | |
| (%) | | | | | |
| L value | 4.5 | 25 | 4.5 | 4.5 | 4.5 |
| Printing | ∘ | x | ∘ | ∘ | ∘ |
| transmissivity | | | | | |
| Printing | 3 | 4 | 4 | 4 | 4 |
| stability | | | | | |
| Red-based | 17.1 | 17.2 | — | 17.1 | 17.2 |
| print | | | | | |
| transmittance | | | | | |
| (%) | | | | | |

TABLE 6

| | Sample | Sample | Sample | Sample | Sample |
|---|---|---|---|---|---|
| | 12 | 13 | 14 | 15 | 16 |
| Base material | PET | PET | PET | PET | PET |
| film | | | | | |
| Green-based | Green | Green | Green | Green | Green |
| colored layer | colored | colored | colored | colored | colored |
| | layer 1 | layer 1 | layer 1 | layer 1 | layer 1 |
| Middle layer | Middle | Middle | Middle | Middle | Middle |
| | layer 4 | layer 5 | layer 6 | layer 7 | layer 8 |
| Red colored | Red | Red | Red | Red | Red |
| layer | colored | colored | colored | colored | colored |
| | layer 1 | layer 1 | layer 1 | layer 1 | layer 1 |
| Red dye:Red | 10:0 | 10:0 | 10:0 | 10:0 | 10:0 |
| pigment | | | | | |
| Transmittance | 87 | 87 | 87 | 87 | 87 |
| of base | | | | | |
| material film | | | | | |
| (%) | | | | | |
| L value | 4.5 | 4.5 | 4.5 | 4.5 | 4.5 |
| Printing | ∘ | ∘ | ∘ | ∘ | ∘ |
| transmissivity | | | | | |
| Printing | 3 | 3 | 3 | 2 | 1 |
| stability | | | | | |
| Red-based | 17.2 | 17.3 | 17.1 | 17.2 | 17.1 |
| print | | | | | |
| transmittance | | | | | |
| (%) | | | | | |

Based on the comparison between the L values of the ink ribbons used in Samples 1 to 7 and Samples 9 to 16, in which there is a complementary color relationship between the red-based colored layer and the green-based colored layer, and the L value of the ink ribbon used in Sample 8, in which there is no such complementary color relationship, it was found that the color difference of reflected light from the red-based colored layer side of the ink ribbon (ink ribbon) can have an L value of 20 or less and thereby the transfer-completed film can exhibit good printing transmissivity as long as there is a complementary color relationship between the red-based colored layer and the green-based colored layer. That is, in the transfer-completed films of Samples 1 to 7 and Samples 9 to 16, the green-based colored layer can be recognized as black when viewed through the transparent base material film and the red-based colored layer. Also, based on the comparison between Samples 1 and 3 and Sample 4, it is possible to more favorably bring the color closer to black particularly when the L value is 15 or less. On the other hand, based on the comparison between Sample 4 and Sample 6, it was found that even in a case of having the same L value, the printing transmissivity can be improved by using a matte-finished transparent PET film as the base material film.

It was also found that the printing transmissivity can be improved by increasing the ratio of the red dye in the red-based colored layer. Comparing the transmittance of the red-based colored layers of Sample 1 (red dye:red pigment=10:0), Sample 3 (red dye:red pigment=7:3), and Sample 4 (red dye:red pigment=5:5), it was found that the transmittance can also be improved as the ratio of the red dye increases. In particular, the red-based colored layers of Sample 1 shows high transmittance.

Next, based on the comparison between Sample 1 and Sample 2, it was found that an improvement in the printing stability is exhibited when the middle layer is interposed between the green-based colored layer and the red-based colored layer. That is, it was found that interposition of the middle layer reduces the extra peeling and enables recording of characters with excellent sharpness. Further, from the viewpoint of printing stability, based on the comparison between Samples 1 and 10 to 12 and Sample 13 to 16, it was found that styrene-based thermoplastic elastomer (SEBS, SBS) is preferable as the middle layer, and SEBS is particularly preferable. Moreover, based on the comparison between Sample 1 and Sample 7, it was found that it is preferable to contain an acrylic adhesive in the green-based colored layer in order to improve the printing stability.

### REFERENCE SIGNS LIST

2: printer tape
3: ink ribbon
35: base material layer
36: first ink layer
37: second ink layer
42: first portion
43: second portion
44: printing pattern
45: second color pattern
46: first color pattern
51: middle layer
55: transfer-completed tape
56: print product
57: first transfer layer
58: second transfer layer
61: base material layer
62: first adhesive layer
63: second adhesive layer
64: peel-off layer
76: sticking tape

1. A thermal transfer recording medium to be transferred to a transparent film, comprising:
a base material layer; and
a first ink layer and a second ink layer that are sequentially laminated on the base material layer, wherein
the second ink layer has translucency that allows for visual recognition of the first ink layer, and has a complementary color relationship with the first ink layer.

2. The thermal transfer recording medium according to claim 1, wherein the color difference of reflected light from the second ink layer has an L value of 20 or less.

3. The thermal transfer recording medium according to claim 1, wherein the second ink layer contains 50 mass % or more of a dye as a color material.

4. The thermal transfer recording medium according to claim 1, wherein the first ink layer contains thermoplastic resin and adhesive.

5. The thermal transfer recording medium according to claim 1, wherein the second ink layer contains thermoplastic resin and wax.

6. The thermal transfer recording medium according to claim 1, further comprising a middle layer that is formed between the first ink layer and the second ink layer.

7. The thermal transfer recording medium according to claim 6, wherein the middle layer contains styrene-based thermoplastic elastomer.

8. A transfer-completed film with a first ink layer, a second ink layer having translucency that allows for visual recognition of the first ink layer, and a transparent film laminated in this order, wherein
the second ink layer has a complementary color relationship with the first ink layer.

9. The transfer-completed film according to claim 8, comprising: a print product that includes a laminated body of the transparent film, the first ink layer, and the second ink layer; and a stick layer that includes a first adhesive layer laminated on the print product on the first ink layer side and a base material layer stuck to the print product with the first adhesive layer therebetween.

10. The transfer-completed film according to claim 9, wherein the stick layer further includes a second adhesive layer laminated on the base material layer on a side opposite to the first adhesive layer and a peel-off layer laminated on the base material layer with the second adhesive layer therebetween.

11. A method of producing a transfer-completed film, comprising:
a heating step of heating a thermal transfer recording medium that has a base material layer and a laminated body of a first ink layer and a second ink layer sequentially laminated on the base material layer, in which the second ink layer has translucency that allows for visual recognition of the first ink layer, and the second ink layer has a complementary color relationship with the first ink layer, in a state where the second ink layer is in contact with a transparent film;
a cooling step of cooling the thermal transfer recording medium that has been heated in the heating step; and
a transferring step of transferring a transfer layer that includes at least the laminated body of the first ink layer and the second ink layer to the transparent film by applying an external force to the base material layer and the first ink layer of the thermal transfer recording medium that has been cooled in the cooling step in a direction in which the layers are separated from each other.

12. The transfer-completed film producing method according to claim 11, wherein
in the heating step, a first portion of the thermal transfer recording medium is heated through application of relatively low first energy and a second portion of the thermal transfer recording medium is heated through application of second energy that is relatively higher than the first energy, and
in the transferring step, the laminated body of the first ink layer and the second ink layer is transferred to the transparent film in the first portion of the thermal transfer recording medium and the second ink layer is selectively transferred to the transparent film in the second portion of the thermal transfer recording medium.
